(19) United States
(12) Patent Application Publication
(10) Pub. No.: US 2008/0247172 A1
(43) Pub. Date: Oct. 9, 2008

(54) Light recycling illumination systems having restricted angular output

(75) Inventors: Karl W. Beeson, Princeton, NJ (US); Scott M. Zimmerman, Basking Ridge, NJ (US)

Correspondence Address: William Propp, Esq.;Goldeneye, Inc., Suite 233, 9747 Businesspark Avenue, San Diego, CA, 92131, US

(73) Assignee: Goldeneye, Inc.

(21) Appl. No.: 12/001,962

(22) Filed: Dec. 12, 2007

Related U.S. Application Data
(63) Continuation-in-part of application No. 10/952,230, filed on Sep. 28, 2004, now Pat. No. 7,370,993.

(51) Int. Cl. F21V 5/02; F21V 7/00

(52) U.S. Cl. 362/308

(57) ABSTRACT

This invention is an illumination system that incorporates a light emitting diode and a partially reflecting optical element. The light emitting diode emits internally generated light having a first angular range and reflects incident light with high reflectivity. The partially reflecting optical element transmits a first portion of the internally generated light with a second angular range, smaller than the first angular range, and reflects a second portion of the internally generated light back to the light emitting diode, where the second portion is reflected by the light emitting diode. The partially reflecting optical element can be a pyramid, an array of pyramids, a first and second orthogonal arrays of prisms or a bandpass filter. Utilizing a partially reflecting optical element and light recycling can increase the effective brightness and the output efficiency of the illumination system.

### CROSS REFERENCES TO RELATED APPLICATIONS

This application is a continuation-in-part patent application of U.S. patent application Ser. No. 10/952,230, entitled “LIGHT RECYCLING ILLUMINATION SYSTEMS HAVING RESTRICTED ANGULAR OUTPUT”, commonly assigned as the present application, commonly invented as the present application and herein incorporated by reference.

This application is related to U.S. Pat. No. 6,869,206 entitled “ILLUMINATION SYSTEMS UTILIZING HIGHLY REFLECTIVE LIGHT EMITTING DIODES AND LIGHT RECYCLING TO ENHANCE BRIGHTNESS,” to U.S. Pat. No. 6,960,872 entitled “ILLUMINATION SYSTEMS UTILIZING LIGHT EMITTING DIODES AND LIGHT RECYCLING TO ENHANCE OUTPUT RADIANCE” and to U.S. Pat. No. 7,040,774 entitled “ILLUMINATION SYSTEMS UTILIZING MULTIPLE WAVELENGTH LIGHT RECYCLING,” all of which are herein incorporated by reference.

This application is also related to U.S. patent application Ser. No. 10/952,112 entitled “LIGHT EMITTING DIODES EXHIBITING BOTH HIGH REFLECTIVITY AND HIGH LIGHT EXTRACTION,” U.S. patent application Ser. No. 10/977,923 entitled “HIGH BRIGHTNESS LIGHT EMITTING DIODE LIGHT SOURCE” and U.S. patent application Ser. No. 10/952,229 entitled “LIGHT RECYCLING ILLUMINATION SYSTEMS UTILIZING LIGHT EMITTING DIODES,” all of which are filed concurrently with this application and are herein incorporated by reference.

### TECHNICAL FIELD

The present invention relates to illumination systems incorporating light emitting diodes and utilizing light recycling.

### BACKGROUND

Light emitting diodes (LEDs) are rapidly replacing incandescent and fluorescent light sources for many illumination applications. LEDs emit light in the ultraviolet, visible and infrared regions of the optical spectrum. Gallium nitride (GaN) based LEDs, for example, emit light in the ultraviolet, blue, cyan and green spectral regions. Aluminum gallium indium phosphide (AlGaInP) LEDs emit light in the yellow and red regions of the optical spectrum.

An example of a prior-art, low-power LED is illustrated schematically as LED 1000 in FIG. 1. In this specification, a low-power LED is defined as an LED that emits less than 50 milliwatts of optical power and has no light extracting elements on the output surface or surfaces of the LED.

An example of a prior-art, high-power LED is shown in FIG. 2 as LED 1100. In this specification, a high-power LED is defined as an LED that includes light extracting elements and emits greater than 100 milliwatts of optical power. Many types of light extracting elements can be used to increase LED light output. In FIG. 2, the light extracting elements are depressions located on the upper output surface of the LED.

Prior art LED 1000 and prior art LED 1100 include a multi-layer semiconductor structure 1012, a reflecting layer 1022 and a top electrode 1024. The reflecting layer 1022 is also the bottom electrode for the LED. The multi-layer semiconductor structure has a top surface 1016, a bottom surface 1018 and incorporates several layers including an n-doped layer, a p-doped layer and an active layer 1014. For simplicity, only the active layer is indicated in the figures. The multi-layer semiconductor structure may optionally include other types of layers such as, for example, current spreading layers or electron blocking layers.

LED 1000 has no light extracting elements in the top surface 1016 of the multi-layer semiconductor structure. LED 1100, on the other hand, has light extracting elements 1102 in the top surface 1016 of the multi-layer semiconductor structure. Light extracting elements improve light extraction from LED 1100 and increase the LED light output power. High-power LEDs require some type of light extracting elements.

In this specification, two types of light will be discussed in relation to LED structures. The two types of light are “internally generated light” and “externally incident light”, both of which are illustrated in FIG. 1 and FIG. 2. Internally generated light is emitted by the active layer 1014 of the LEDs. Light rays 1030 and 1034 in FIG. 1 are internally generated light emitted by active layer 1014 of LED 100. Light ray 1110 in FIG. 2 is internally generated light emitted by active layer 1014 of LED 1100.

Externally incident light is light that is directed to the LED from outside the LED. The externally incident light can be light that comes from other sources, such as other LEDs, or the externally incident light can be light that has exited the LED light source and has subsequently been reflected or redirected back to the emitting LED. Externally incident light can be reflected or absorbed by the outer surface of the LED or can enter the LED structure and be reflected or absorbed by the interior layers or surfaces of the LED.

Examples of externally incident light rays that are reflected by the outer surfaces of the LEDs include externally incident light ray 1038 in FIG. 1 and externally incident light ray 1114 in FIG. 2. Both light ray 1038 and light ray 1114 are reflected by the top electrode of the respective LED. The top electrode is normally a metal and, and depending on the type of metal, has a reflectivity ranging from about 30 percent to about 70 percent or more. For example, if the metal is gold, the reflectivity of the metal surface is approximately 35 percent if the reflected light has a wavelength of 460 nm.

Examples of externally incident light rays that enter the LED structure include externally incident light ray 1036 in FIG. 1 and externally incident light ray 1112 in FIG. 2. Example externally incident light ray 1036 in FIG. 1 enters LED 1000 through surface 1016, passes through the multi-layer semiconductor structure 1012 a first time, is reflected by reflecting layer 1022, passes through the multi-layer semiconductor structure a second time and exits LED 1000 though surface 1016. When surfaces 1016 and 1018 of the multi-layer semiconductor structure are smooth with no light extracting elements, externally incident light entering the structure will either be absorbed by the LED structures or will exit the LED after only two passes through the multi-layer semiconductor structure.

Externally incident light ray 1112 enters LED 1100 through a light extracting element 1102 on surface 1016. Externally incident light ray passes through the multi-layer semiconductor structure 1012 a first time, is reflected by reflecting layer 1022 a first time, passes through the multi-layer semiconductor structure a second time and undergoes total internal refection two times at the top surface of the LED. Light ray 1112 subsequently passed through the multi-layer semiconductor structure four additional times, undergoes total internal reflection at surface 1016 two additional times and is reflected by the reflecting layer two additional times before exiting LED 1100 through a light extracting element 1102. When surface 1016 of the multi-layer semiconductor structure includes light extracting elements, externally incident light entering the structure may pass through the structure more than two times before exiting the LED. Example light ray 1112 in FIG. 2 passes through the multi-layer semiconductor structure six times before exiting the LED. The greater the number of times a light ray passes through the multi-layer semiconductor structure and the greater the number of times the light ray is reflected by the reflecting layer, the higher the chances that the light ray will be absorbed and not exit the LED. Less externally incident light is reflected and more externally incident light is absorbed by an LED that has light extracting elements than by an LED that does not have light extracting elements.

There are three critical issues that currently restrict LED deployment in many applications. The first critical issue is that LEDs typically have low external quantum efficiencies for internally generated light. When the external quantum efficiency of an LED is low for internally generated light, the LED produces fewer lumens per watt than a standard fluorescent lamp, thereby slowing the changeover to LEDs in new light source designs.

The second issue is that LEDs may lack sufficient brightness for demanding applications that now use arc lamp sources. Applications such as large area projection displays require high-brightness light sources that can emit several watts of optical power into a source area of less than 10 mm². Present LEDs do not achieve this level of output power in such a small area. One reason for the insufficient brightness is the low external quantum efficiency of the LEDs for internally generated light. The two effects of low external quantum efficiency and low output brightness are related.

Third, the reflectivity of an LED to externally incident light is critically important for applications where some of the internally generated light emitted into the external environment by the LED is reflected or recycled back to the LED. For example, U.S. Pat. No. 6,869,206 by Zimmerman and Beeson, U.S. Pat. No. 6,960,872 by Beeson and Zimmerman and U.S. Pat. No. 7,040,774 by Beeson and Zimmerman disclose that light recycling can be utilized to construct enhanced brightness LED optical illumination systems. In the above-mentioned patents, the LEDs are located inside light reflecting cavities or light recycling envelopes and light is reflected back to the LEDs in order to enhance the brightness of the LEDs. For example, in FIG. 1, the reflection of externally incident light rays 1036 and 1038 adds to the internally generated light exiting the LED 100, illustrated by internally generated light ray 1034, and increases the effective brightness of the LED. However, if the LED has poor reflectivity to externally incident light, some of the externally incident light will be absorbed by the LED, reducing both the brightness enhancement and the overall efficiency of the LED light source.

Consider first the external quantum efficiency of an LED. The external quantum efficiency is equal to the internal quantum efficiency for converting electrical energy into photons multiplied by the light extraction efficiency. The internal quantum efficiency, in turn, is dependent on many factors including the device structure as well as the electrical and optical properties of the LED semiconductor materials.

The light extraction efficiency of an LED die is strongly dependent on the refractive index of the LED relative to its surroundings, to the shape of the die, and to the presence or absence of light extracting elements that can enhance light extraction of internally generated light. For example, increasing the refractive index of the LED relative to its surroundings will decrease the light extraction efficiency. An LED die with flat external sides and right angles to its shape will have lower light extraction efficiency than an LED with beveled sides. An LED, such as LED 1000 in FIG. 1, with no light extracting elements on the output surface will have lower light extraction efficiency than an LED, such as LED 1100 in FIG. 2, which has light extracting elements on the output surface.

LEDs that have no light extracting elements have light extraction efficiencies of approximately 10 percent or less and are generally used for low-power applications that do not require much light emission. LED 1000 in FIG. 1 is an example of a low-power LED. If the low-power LED structure is overcoated with a hemispherical polymer overcoat, the light extraction efficiency is approximately doubled to about 20 percent. The reason for the low light extraction efficiency of LEDs with no light extracting elements is due to the high refractive index (n>2) of the solid-state LED semiconductor materials. For example, GaN-based LED materials have a refractive index of approximately 2.5.

If the LED die has a refractive index n_{die}, has flat external surfaces with no light extracting elements as in FIG. 1, and is in contact with an external material, such as air or a polymer overcoat, that has a refractive index nₑₓₜ, only internally generated light that has an angle less than the critical angle will exit from the die. The remainder of the internally generated light will undergo total internal reflection at the inside surfaces of the die and remain inside the die. The critical angle θ_{c} inside the die is given by

θ_{c}=arcsin(nₑₓₜ/n_{die}) [Equation 1]

where θ_{c} is measured relative to a direction perpendicular to the LED output surface. For example, if the external material is air with a refractive index nₑₓₜ of 1.00 and the refractive index n_{die} is 2.5, the critical angle is approximately 24 degrees. Only internally generated light having incident angles between zero and 24 degrees will exit from the LED die. The majority of the light generated by the active region of the LED will strike the surface interface at angles between 24 degrees and 90 degrees and will undergo total internal reflection. The light that is totally internally reflected will remain in the die until it is either absorbed or until it reaches a perpendicular surface that may allow the light to exit.

In FIG. 1, example internally generated light ray 1030 is directed to surface 1016 at an angle 1032 that is greater than the critical angle. Internally generated light ray 1030 undergoes total internal reflection and remains inside the LED structure. However, example internally generated light ray 1034, after first reflecting from reflecting layer 1022, is directed to surface 1016 at an angle 1036 that is less than the critical angle and can thereby exit the LED.

High-power LEDs that emit greater than 100 milliwatts of optical power have light extracting elements in order to increase their light extraction efficiency and increase the total light output. However, even with the inclusion of light extracting elements, the light extraction efficiency of prior-art, high-power LEDs is typically 30 percent or less. The low values are due primarily to absorption of internally generated light within the LED structure. Light can be absorbed both by the multi-layer semiconductor structure 1012 and by the reflecting layer 1022.

The effects of material absorption on the light extraction efficiency of internally generated light and the reflectivity of LEDs to externally incident light will now be considered.

The absorption of light by the LED die can strongly influence the overall light extraction efficiency of the LED. The transmission T of light that is transmitted through an optical pathlength P of an LED die having an absorption coefficient alpha, denoted by the Greek letter α, is given by

T=e^{-αP} [Equation 2]

In order for the absorption of light for a pathlength P to be less than 20 percent, for example, or, conversely, the transmission T to be greater than 80 percent, then the quantity αP in Equation 2 should be about 0.2 or less.

The absorption coefficient alpha is usually not uniform across the different semiconductor layers of the multi-layer semiconductor structure 1012. Since the different semiconductor layers that make up the multi-layer semiconductor structure have different absorption coefficients, the absorption coefficient alpha for the multi-layer semiconductor structure is defined in this specification as the thickness-weighted-average absorption coefficient. The weighting function is the fractional thickness of each semiconductor layer in the multi-layer semiconductor structure 1012. For example, if 100 percent of the thickness of the multi-layer semiconductor structure has a uniform absorption coefficient of 200 cm⁻¹ in the emitting wavelength range, then the thickness-weighted-average absorption coefficient alpha is 200 cm⁻¹. In a second example, if 50 percent of the thickness of the multi-layer semiconductor structure has an absorption coefficient of 50 cm⁻¹ and 50 percent of the thickness of the multi-layer semiconductor structure has an absorption coefficient of 350 cm⁻¹, then the thickness-weighted-average absorption coefficient alpha is also 200 cm⁻¹.

As indicated in FIGS. 1 and 2, prior art LEDs have an absorption coefficient alpha, i.e. the thickness-weighted-average absorption coefficient, which is greater than 100 cm⁻¹ or, equivalently, 0.01 per micron. If α=200 cm⁻¹ or 0.02 per micron, for example, then P should be less than about 0.001 centimeters or 10 microns in order to keep the absorption less than about 20 percent or the transmission greater than 80 percent. Since many LED die materials have semiconductor layers with absorption coefficients much higher than 100 cm³¹¹ and since many LED dies have lateral dimensions of 300 microns or larger, a large fraction of the light generated by the die may be absorbed inside the die before it can be extracted.

The reflectivity of reflecting layer 1022 also affects the light extraction efficiency of the LED. Increasing the reflectivity of the reflecting layer 1022 decreases absorption of the internally generated light inside the LED structure and increases the light extraction efficiency for internally generated light.

Consider now the reflectivity of an LED to externally incident light. The overall reflectivity of an LED to externally incident light depends not only on the reflectivity of the reflecting layer 1022 and the reflectivity of the top electrode 1024, but also is strongly affected by the absorption coefficient alpha of the multi-layer semiconductor structure. For example, consider externally incident light ray 1036 for a low-power LED in FIG. 1. Assume, for example, that the multi-layer semiconductor structure 1012 is 4 microns thick and that alpha is 200 cm⁻¹ or 0.02 per micron. Also assume the reflecting layer 1022 has a reflectivity of 90 percent, a value that is typical for many prior art LEDs. The optical pathlength of the angled ray 136 for a single pass through the multi-layer semiconductor structure is approximately 4.4 microns. The total pathlength for two passes within the multi-layer semiconductor structure is 8.8 microns. From Equation 2, the transmission through 8.8 microns of material is 84 percent. The reflectivity of LED 1000 to externally incident light ray 1036 is equal to the transmission percentage factor through the multi-layer semiconductor structure times the reflectivity of the reflecting layer. For externally incident light ray 1036, the resulting values are 84 percent (the transmission factor) times 90 percent (the reflectivity of the reflecting layer) or 75 percent. The low-power LED 1000 reflects 75 percent of externally incident light ray 136.

From the previous example, it is evident that low-power LEDs with no light extracting elements can reflect 70 percent or more of externally incident light. However, low-power LEDs do not emit enough light for many applications such as, for example, projection displays that require high output power in a small emitting area.

Now consider externally incident light ray 1112 for the high-power LED in FIG. 2. Again assume that the multi-layer semiconductor structure 1012 is 4 microns thick and that alpha is 200 cm⁻¹ or 0.02 per micron. Also assume the reflecting layer 1022 has a reflectivity of 90 percent. The optical pathlength of the angled ray 1112 for a single pass through the multi-layer semiconductor structure is approximately 6 microns. The total pathlength for six passes within the multi-layer semiconductor structure plus the multiple internal reflections from surface 1016 is approximately 40 microns. From Equation 2, the transmission factor is 45 percent. In addition, light ray 1112 reflects three times from the reflecting layer. Three reflections at 90 percent each gives a reflection factor of 73 percent. The reflectivity of LED 1100 to externally incident light ray 1112 is equal to the transmission percentage factor through the multi-layer semiconductor structure times the reflection factor due to three reflections from the reflecting layer. For externally incident light ray 1112, the resulting values are 45 percent (the transmission factor) times 73 percent (from the three reflections) or 33 percent. The high-power LED 1100 reflects only 33 percent of externally incident light ray 212.

Externally incident light rays that follow different optical paths through LED 1100 will each have a different effective reflectivity values. If one considers many externally incident light rays directed to a prior-art, high-power LED from all directions, the overall average reflectivity of the prior-art, high-power LED is typically less than about 50 percent.

Now consider other factors that effect LED light extraction efficiency and the reflectivity of LEDs to externally incident light.

Some LED dies incorporate a growth substrate, such as sapphire or silicon carbide, upon which the semiconductor layers are fabricated. U.S. Patent Application Serial No. 20050023550 discloses how the absorption coefficient of the growth substrate as well as the thickness of the growth substrate can affect the light extraction efficiency of an LED die. If the growth substrate remains as part of the LED die, either reducing the absorption coefficient of the growth substrate or reducing the thickness of the growth substrate increases the light extraction efficiency. However, U.S. Patent Application Serial No. 20050023550 does not disclose how the absorption coefficient of the semiconductor layers affects the light extraction efficiency of the LED die or the reflectivity of the LED die to externally incident light.

Many ideas have been proposed for increasing the light extraction efficiency of LEDs. These ideas include forming angled (beveled) edges on the die, adding non-planar surface structures to the die, roughening at least one surface of the die, and encapsulating the die in a lens that has a refractive index intermediate between the refractive index of the die n_{die} and the refractive index of air. For example, it is a common practice to enclose a low-power LED within a hemispherical lens or a side-emitting lens in order to improve the light extraction efficiency. LEDs with side emitting lenses are disclosed in U.S. Pat. No. 6,679,621 and U.S. Pat. No. 6,647,199. A typical hemispherical lens or side-emitting lens has a refractive index of approximately 1.5. More light can exit from the LED die through the lens than can exit directly into air from the LED die in the absence of the lens. Furthermore, if the lens is relatively large with respect to the LED die, light that exits the die into the lens will be directly approximately perpendicular to the output surface of the lens and will readily exit through the lens. However, the typical radius of the hemispherical lens or the height of the side-emitting lens in such devices is 6 mm or larger. This relatively large size prevents the use of the lens devices in, for example, ultra-thin liquid crystal display (LCD) backlight structures that are thinner than about 6 mm or in projection displays that require very small LED sources. In order to produce ultra-thin illumination systems or projection light sources, it would be desirable to eliminate the lens but still retain high light extraction efficiency. U.S. Pat. No. 6,679,621 and U.S. Pat. No. 6,647,199 do not disclose how the absorption coefficient of the semiconductor layers affects the light extraction efficiency of the LED die or the reflectivity of the LED die to externally incident light.

U.S Patent Application Ser. No. 20020123164 discloses using a series of grooves or holes fabricated in the growth substrate portion of the die as light extracting elements. The growth substrate portion of the die can be, for example, the silicon carbide or sapphire substrate portion of a die onto which the GaN-based semiconductor layers are grown. However, in U.S Patent Application Ser. No. 20020123164 the grooves or holes do not extend into the semiconductor layers. If the substrate is sapphire, which has a lower index of refraction than GaN, much of the light can still undergo total internal reflection at the sapphire-semiconductor interface and travel relatively long distances within the semiconductor layers before reaching the edge of the die. U.S. Patent Application Serial No. 20020123164 does not disclose how the absorption coefficient of the semiconductor layers affects the light extraction efficiency of the LED die or the reflectivity of the LED die to externally incident light.

U.S. Pat. No. 6,410,942 discloses the formation of arrays of micro-LEDs on a common growth substrate to reduce the distance that emitted light must travel in the LED die before exiting the LED. Micro-LEDs are formed by etching trenches or holes through the semiconductor layers that are fabricated on the growth substrate. Trenches are normally etched between LEDs on an array to electrically isolate the LEDs. However, in U.S. Pat. No. 6,410,942 the growth substrate remains as part of the micro-LED structure and is not removed. The growth substrate adds to the thickness of the LED die and can reduce the overall light extraction efficiency of the array. Even if light is efficiently extracted from one micro-LED, it can enter the growth substrate, undergo total internal reflection from the opposing surface of the growth substrate, and be reflected back into adjacent micro-LEDs where it may be absorbed. U.S. Pat. No. 6,410,942 does not disclose how the absorption coefficient of the semiconductor layers affects the light extraction efficiency of the LED die or the reflectivity of the LED die to externally incident light.

Increasing the density of light extracting elements by decreasing the size of micro-LEDs illustrated in U.S. Pat. No. 6,410,942 may increase the light extraction efficiency of a single micro-LED, but can also decrease the reflectivity of the micro-LED to incident light. The same structures that extract light from the LED die also cause light that is externally incident onto the die to be injected into the high-loss semiconductor layers and to be transported for relatively long distances within the layers. Light that travels for long distances within the semiconductor layers is strongly absorbed and only a small portion may escape from the die as reflected light. In one embodiment of U.S. Pat. No. 6,410,942, the micro-LEDs are circular with a diameter of 1 to 50 microns. In another embodiment, the micro-LEDs are formed by etching holes through the semiconductor layers resulting in micro-LEDs with a preferred width between 1 and 30 microns. Micro-LEDs with such a high density of light extracting elements can result in reduced reflectivity for externally incident light, which is undesirable for many light recycling applications.

U.S. Pat. No. 6,495,862 discloses forming an embossed surface on the LED to improve light extraction. The surface features can include cylindrical or spherical lens-shaped convex structures. However, U.S. Pat. No. 6,495,862 does not disclose how the absorption coefficient of the semiconductor layers affects the light extraction efficiency of the LED die or the reflectivity of the LED die to externally incident light.

T. Fujii et al in Applied Physics Letters (volume 84, number 6, pages 855-857, 2004) disclose forming hexagonal cone-like structures on the LED surface to improve light extraction. A two-fold to three-fold increase in light extraction efficiency was obtained by this method. In this paper, T. Fujii does not disclose how the absorption coefficient of the semiconductor layers affects the light extraction efficiency or the reflectivity of the LED die to externally incident light.

Many commercially available LEDs, including the GaN-based LEDs made from GaN, InGaN, AlGaN and AlInGaN, have relatively low reflectivity (less than 50 percent) to externally incident light. As described above, one reason for the low reflectivity is that the semiconductor layers have relatively high optical absorption at the emitting wavelength of the internally generated light. Due to problems fabricating thin layers of the semiconductor materials, a thickness-weighted-average absorption coefficient greater than 100 cm⁻¹ is typical.

Another reason for the low reflectivity to externally incident light for many present LED designs is that the LED die may include a substrate that absorbs a significant amount of light. For example, GaN-based LEDs with a silicon carbide substrate are usually poor light reflectors to externally incident light with an overall reflectivity of less than 50 percent.

An additional reason for the low reflectivity to externally incident light for many present LED designs is external structures on the LEDs, including the top metal electrodes, metal wire bonds and sub-mounts to which the LEDs are attached, that are not designed for high reflectivity. For example, the top metal electrodes and wire bonds on many LEDs contain materials such as gold that have relatively poor reflectivity. Reflectivity numbers on the order of 35 percent in the blue region of the optical spectrum are common for gold electrodes.

Prior art LED designs have either relatively low optical reflectivity to externally incident light (less than 50 percent, for example) or have high reflectivity to externally incident light combined with low light extraction efficiency (for example, less than 20 percent). For many applications, including illumination systems utilizing light recycling, it would be desirable to have LEDs that exhibit both high reflectivity (greater than 60 percent) to externally incident light and high light extraction efficiency (greater than 40 percent). It would also be desirable to develop LEDs that do not require a large transparent optical element such as a hemispherical lens in order to achieve high light extraction efficiency. LEDs that do not have such lens elements are thinner and take up less area than traditional LEDs. Such ultra-thin LEDs having high light extraction efficiency and high reflectivity to externally incident light can be used, for example, in light recycling cavities to increase the effective brightness of the LED light source.

Illumination systems that contain blackbody light sources such as arc lamp sources or incandescent sources are usually designed so that no light is reflected or recycled back to the source. Blackbody light sources are excellent light absorbers and poor light reflectors. Any emitted light that does get back to the source is absorbed and lost, lowering the overall efficiency of the illumination system.

Certain types of light sources, such as some fluorescent light sources and some light emitting diodes (LEDs), can reflect light as well as emit light. Reflecting light sources can be used in illumination systems that recycle light back to the source. Recycled light that is returned to the source and that is subsequently reflected by the source can increase the effective brightness of the source. In addition, light sources that can reflect light instead of absorbing light can reduce absorption losses and increase the overall output efficiency of illumination systems.

The technical term brightness can be defined either in radiometric units or photometric units. In the radiometric system of units, the unit of light flux or radiant flux is expressed in watts and the unit for brightness is called radiance, which is defined as watts per square meter per steradian (where steradian is the unit of solid angle). The human eye, however, is more sensitive to some wavelengths of light (for example, green light) than it is to other wavelengths (for example, blue or red light). The photometric system is designed to take the human eye response into account and therefore brightness in the photometric system is brightness as observed by the human eye. In the photometric system, the unit of light flux as perceived by the human eye is called luminous flux and is expressed in units of lumens. The unit for brightness is called luminance, which is defined as lumens per square meter per steradian. The human eye is only sensitive to light in the wavelength range from approximately 400 nanometers to approximately 700 nanometers. Light having wavelengths less than about 400 nanometers or greater than about 700 nanometers has zero luminance, irrespective of the radiance values.

U.S. Pat. No. 6,869,206, U.S. Pat. No. 6,960,872 and to U.S. Pat. No. 7,040,774 describe light recycling systems that include light recycling cavities or envelopes that enclose one or more light reflecting LEDs. The light reflecting cavities or envelopes reflect and recycle a portion of the light emitted by the LEDs back to the LEDs. The light recycling cavity or envelope has an output aperture with an area that is smaller than the total emitting area of the enclosed LEDs. In such cases, it is possible for the light exiting the cavity or envelope to be brighter than an equivalent LED measured in the absence of recycling.

The three aforementioned applications disclose light recycling illumination systems that have substantially Lambertian light outputs. The light output distributions of these illumination systems generally extend from approximately −90 degrees to approximately +90 degrees. However, the three aforementioned applications do not disclose optical elements that both recycle light and restrict the angular range of the light output.

In this specification, angular extent is defined by the maximum emitting angles of the source. A planar Lambertian source, for example, emits light of constant brightness from −90 degrees to +90 degrees, where the angle is measured from a line perpendicular to the source. The angular extent of a planar Lambertian source is therefore −90 degrees to +90 degrees.

The angular range is defined in this specification as the angular spread between the points on the light output distribution where the light flux per steradian is one half of the peak flux per steradian. For a Lambertian distribution, the light flux per steradian is one-half of the peak value at −60 degrees and at +60 degrees. For a Lambertian source, the angular range is 120 degrees.

U.S. patent application Ser. No. 10/952,112 entitled “LIGHT EMITTING DIODES EXHIBITING BOTH HIGH REFLECTIVITY AND HIGH LIGHT EXTRACTION,” U.S. patent application Ser. No. 10/977,923 entitled “HIGH BRIGHTNESS LIGHT EMITTING DIODE LIGHT SOURCE” and U.S. patent application Ser. No. 10/952,229 entitled “LIGHT RECYCLING ILLUMINATION SYSTEMS UTILIZING LIGHT EMITTING DIODES,” disclose illuminations systems that include reflective polarizers or wavelength conversion layers that recycle light. However, the reflective polarizers or wavelength conversion layers do not restrict the angular range of the light output of the illumination systems.

In designing complex optical systems such as projection displays, it is important to try to match the angular light output of the source to the maximum acceptance angles of the remainder of the optical system. For example, some imaging light modulators for projection displays have areas ranging from approximately 150 square millimeters to approximately 520 square millimeters. The imaging light modulators can accept light only for angles between −12 degrees and +12 degrees, for example. For such imaging systems, optimizing the quantity called etendue is important.

When measured in air, a simplified equation for etendue is the product of the area of the light beam times the projected solid angle (measured in steradians) of the light beam. Equation 1 expresses the simplified etendue relationship for an imaging system.

Etendue=(A)(Ω) [Equation 3]

The quantity A is the area of the light beam and Q is the projected solid angle of the light beam. For planar sources, the quantity Q can be expressed as

Ω=π sin² (half-angle). [Equation 4]

The half-angle is one half of the full angle of the light beam. A light beam that has a full angle of 24 degrees (from −12 degrees to +12 degrees) has a half-angle of 12 degrees.

An imaging light modulator that has an area of 250 square millimeters and an acceptance angle of −12 degrees to +12 degrees, for example, has an etendue of approximately 34 mm²-steradians. To effectively utilize the light emitted by the light source, the etendue of the light source for this example should also be approximately 34 mm²-steradians or less. If the output from the light source is Lambertian and extends from −90 degrees to +90 degrees with a range of 120 degrees, the area of the light source should be approximately 11 square millimeters in order for the source to have the same etendue as the imaging light modulator. It is difficult for an LED-based illumination system to have such a small output area and still have sufficient output flux for a large projection display. If the light source output can be restricted to a smaller angular range, however, the source area can be made correspondingly larger.

It would be desirable to design LED light recycling illumination systems that incorporate optical elements that both recycle light and restrict the angular range of the light output. Such systems can have increased output brightness and efficiency compared to systems that do not recycle light. In addition, such systems reduce the etendue of the illumination system output in order to better match the etendue of other optical elements in more complex optical systems such as projection displays.

### SUMMARY OF THE INVENTION

One embodiment of this invention is an illumination system that incorporates at least one light emitting diode and a partially reflecting optical element. The light emitting diode emits internally generated light having a first angular range and reflects incident light with high reflectivity. The partially reflecting optical element transmits a first portion of the internally generated light with a second angular range, smaller than the first angular range, and reflects a second portion of the internally generated light back to the light emitting diode. The partially reflecting optical element can be, for example, a pyramid, an array of pyramids, a first and second orthogonal arrays of prisms or an optical bandpass filter.

Another embodiment of this invention is an illumination system that incorporates at least one light emitting diode, a light recycling envelope that encloses the at least one light emitting diode and a partially reflecting optical element. The light emitting diode emits internally generated light and reflects incident light with high reflectivity. The light recycling envelope has inside reflecting surfaces that recycle a part of the internally generated light emitted by the light emitting diode back to the light emitting diode. The light recycling envelope has an output aperture through which light is directed to the partially reflecting optical element. The light exiting the output aperture has a first angular range. The partially reflecting optical element transmits a first portion of the internally generated light with a second angular range, smaller than the first angular range, and reflects a second portion of the internally generated light back into the light recycling envelope and to the light emitting diode.

By utilizing light recycling and a partially reflecting optical element that restricts the angular range of the light output of an illumination system, one can increase the effective brightness and the output efficiency of the illumination system.

### BRIEF DESCRIPTION OF THE DRAWINGS

A more detailed understanding of the present invention, as well as other objects and advantages thereof not enumerated herein, will become apparent upon consideration of the following detailed description and accompanying drawings, wherein:

FIG. 1 is a simplified schematic view of a prior art, low powered light emitting diode illustrating reflection of internally generated light and externally incident light.

FIG. 2 is a simplified schematic view of a prior art, high powered light emitting diode illustrating reflection of internally generated light and externally incident light.

FIG. 3A is a simplified schematic view of the cross-section of a preferred light emitting diode used in this invention.

FIGS. 3B-3D are cross-sectional views of example LED structures.

FIG. 4A is a plan view of one embodiment of this invention incorporating a four-sided pyramid.

FIG. 4B is a cross-sectional view along the I-I plane illustrated in FIG. 4A.

FIG. 5A is a plan view of another embodiment of this invention incorporating a three-by-three array of four-sided pyramids.

FIG. 5B is a cross-sectional view along the I-I plane illustrated in FIG. 5A.

FIGS. 5C and 5D are expanded views of FIG. 5B.

FIG. 6A is a plan view of another embodiment of this invention incorporating an array of prisms that are aligned with the Y-axis.

FIG. 6B is a cross-sectional view along the I-I plane illustrated in FIG. 6A.

FIGS. 6C and 6D are expanded views of FIG. 6B.

FIG. 7A is a plan view of another embodiment of this invention incorporating an array of prisms that are aligned with the X-axis.

FIG. 7B is a cross-sectional view along the II-II plane illustrated in FIG. 7A.

FIGS. 7C and 7D are expanded views of FIG. 7B.

FIG. 8A is a plan view of another embodiment of this invention incorporating two orthogonal arrays of prisms.

FIG. 8B is a cross-sectional view along the I-I plane illustrated in FIG. 8A.

FIG. 8C is a cross-sectional view along the II-II plane illustrated in FIG. 8A.

FIG. 8D is a perspective view of the embodiment illustrated in FIG. 8A.

FIG. 8E is an expanded view of FIG. 8B.

FIG. 8F is an expanded view of FIG. 8C.

FIG. 9A is a cross-sectional view of another embodiment of this invention incorporating a bandpass filter.

FIG. 9B illustrates example transmission spectra of a bandpass filter as a function of wavelength for two incident angles.

FIG. 10A is a plan view of another embodiment of this invention that incorporates a light recycling envelope and a four-sided pyramid.

FIG. 10B is a cross-sectional view along the I-I plane illustrated in FIG. 10A.

FIGS. 10C and 10D are expanded views of FIG. 10B.

FIGS. 11A and 11B are cross-sectional views of another embodiment of this invention that incorporates a light recycling envelope and an array of four-sided pyramids.

FIG. 12A is a plan view of another embodiment of this invention that incorporates a light recycling envelope and two orthogonal arrays of prisms.

FIG. 12B is a cross-sectional view along the I-I plane indicated in FIG. 12A.

FIG. 12C is a cross-sectional view along the II-II plane indicated in FIG. 12A.

FIGS. 12D and 12E are expanded views of FIG. 12B.

FIG. 13A is a plan view of another embodiment of this invention that incorporates a light recycling envelope and a bandpass filter.

FIGS. 13B-13D are cross-sectional views along the I-I plane illustrated in FIG. 13A.

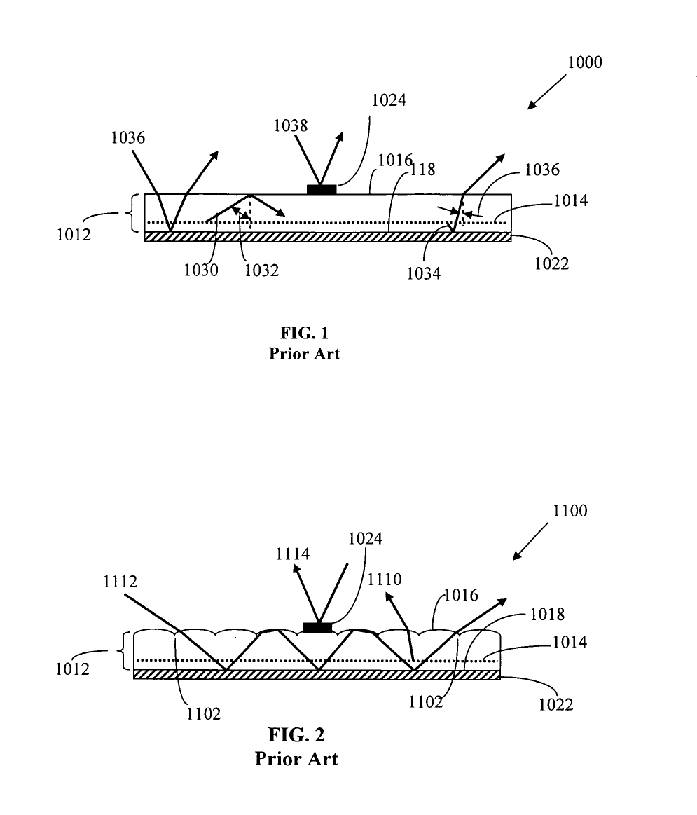

### DETAILED DESCRIPTION OF THE PREFERRED EMBODIMENTS

The preferred embodiments of the present invention will be better understood by those skilled in the art by reference to the above figures. The preferred embodiments of this invention illustrated in the figures are not intended to be exhaustive or to limit the invention to the precise form disclosed. The figures are chosen to describe or to best explain the principles of the invention and its applicable and practical use to thereby enable others skilled in the art to best utilize the invention.

An LED of this invention incorporates a multi-layer semiconductor structure that emits light. Inorganic light-emitting diodes can be fabricated from materials containing gallium nitride (GaN), including the materials aluminum gallium nitride (AlGaN) and indium gallium nitride (InGaN). Other appropriate LED materials are aluminum nitride (AlN), aluminum indium gallium phosphide (AlInGaP), gallium arsenide (GaAs), indium gallium arsenide (InGaAs) or indium gallium arsenide phosphide (InGaAsP), for example, but are not limited to such materials. Especially important LEDs for this invention are GaN-based LEDs that emit light in the ultraviolet, blue, cyan and green region of the optical spectrum and AlInGaP LEDs that emit light in the yellow and red regions of the optical spectrum. For simplicity, the detailed descriptions of LEDs given below will focus on GaN-based devices. AlInGaP LEDs have similar structures except that the semiconductor elements are fabricated from AlInGaP instead of GaN.

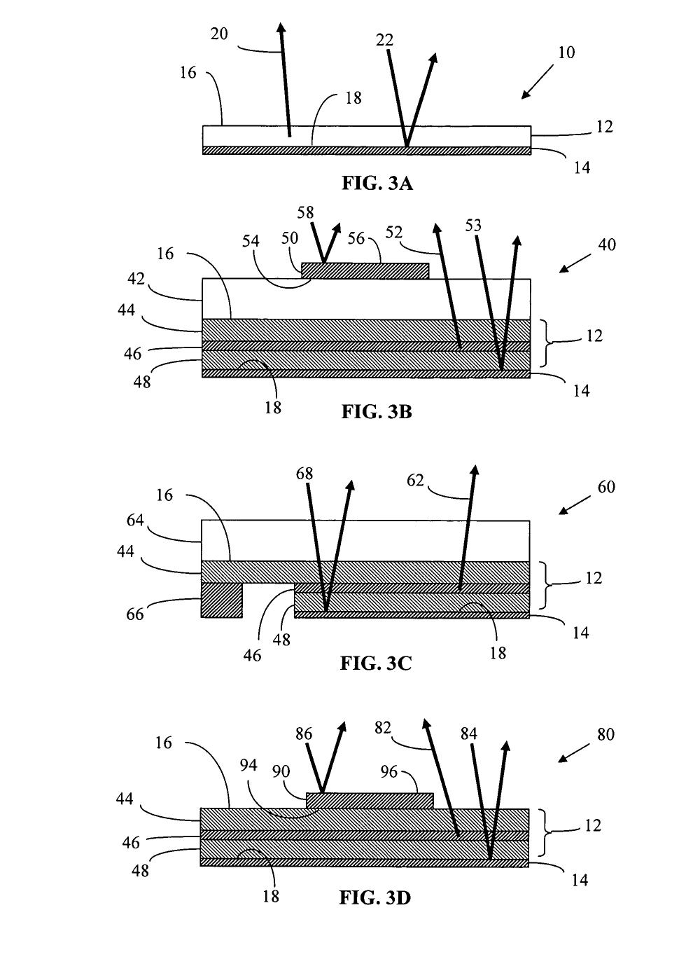

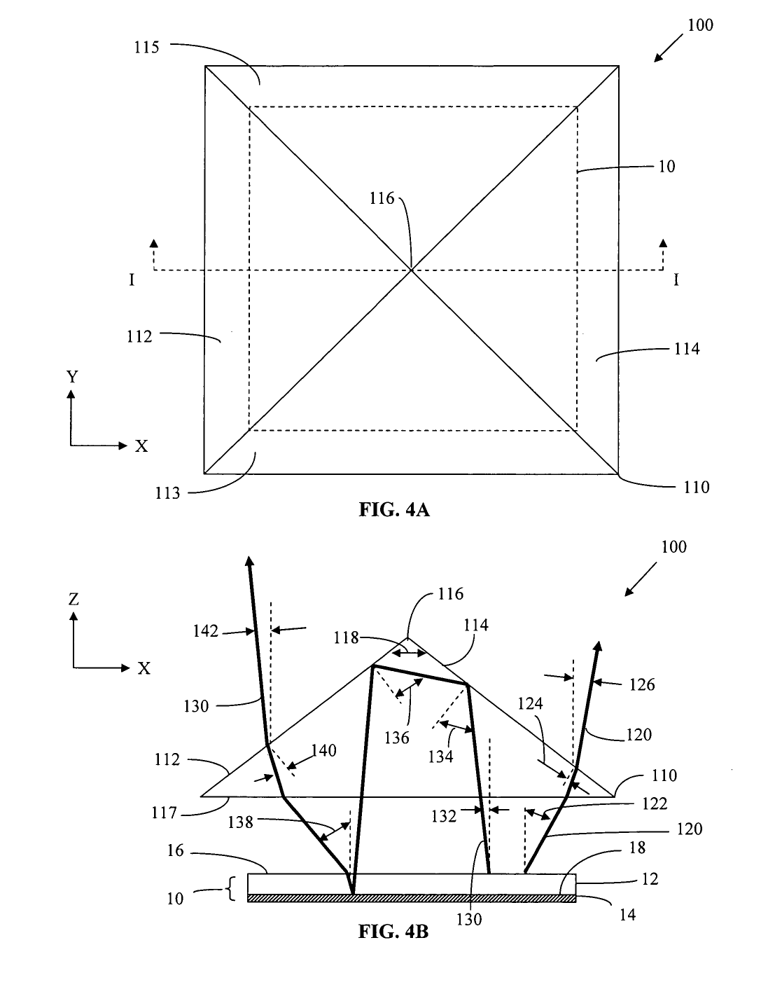

FIG. 3A is a simplified schematic diagram of the cross-section of LED 10. FIG. 3A is an illustrative example. The LED 10 does not show all the elements of a reflective LED for ease of understanding the present invention in FIG. 4 and the subsequent figures. LED 10 is comprised of a multi-layer semiconductor structure 12 and a reflecting layer 14. Multi-layer semiconductor structure 12 is a simplified representation of a multi-layer group of elements that normally includes at least an n-doped layer, a p-doped layer and an active multi-quantum well structure that emits internally generated light. Multi-layer semiconductor structure 12 has a surface 16 through which the internally generated light 20 exits the multi-layer semiconductor structure. Surface 18 of the multi-layer semiconductor structure 12 is in contact with reflecting layer 14. The multi-layer semiconductor structure is usually not completely transparent and does absorb some of the internally generated light before the light exits LED 10. The absorption coefficient for the multi-layer semiconductor structure 12 for GaN-based LEDs ranges from approximately 10 cm⁻¹ to approximately 200 cm⁻¹ in the wavelength region from 400-600 nanometers.

In order to better understand this invention, more detailed schematics of some example LED structures are shown in FIGS. 3B-3D. FIGS. 3B-3D explicitly illustrate example LED electrode structures and some of the elements that comprise the multi-layer semiconductor structure. These examples are for illustrative purposes only and are not meant to limit the scope of this invention to just these examples.

FIG. 3B illustrates the cross-section of LED 40. LED 40 is comprised of reflecting layer 14 that also serves as a bottom electrode, a multi-layer semiconductor structure 12, a substrate 42 and a top electrode 50. The multi-layer semiconductor structure 12 is epitaxially grown onto the substrate 42. Internal light beam 52 is emitted by the light emitting diode 40. Externally incident light beam 58 is reflected by the top surface 56 of the top electrode 50 without being transmitted through the LED 40. Externally incident light beam 53 is transmitted through the top surface of the LED 40, reflected by the reflecting layer 14, transmitted back through the LED 40 and transmitted out of the LED 40.

If LED 40 is a GaN LED, the multi-layer semiconductor structure 12 contains at least an n-doped GaN layer 44 that is usually adjacent to the substrate 42, an active layer 46 that emits internally generated light 52 and a p-doped GaN layer 48. The active layer 46 is typically a GaN-based multi-quantum well structure and is located between the n-doped GaN layer 44 and the p-doped GaN layer 48.

The substrate 42 of LED 40 must be at least partially transparent to the internally generated light 52. Substrate 42 must also be electrically conducting in order to form an electrical path between the n-doped layer 44 and the top electrode 50. A typical material for substrate 42 is doped silicon carbide (SiC), but other materials can be used. SiC is partially transparent, but does absorb some of the internally generated light 52. The absorption coefficient of SiC is approximately 2 cm⁻¹ in the wavelength region from 400-600 nanometers.

A metallic top electrode 50 is in contact with the electrically conducting substrate 42. The area of the top electrode 50 should be minimized in order for internally generated light 52 to escape from the uncovered area of the multi-layer semiconductor structure 12. The top electrode 50 should have high reflectivity in order to efficiently reflect both internally generated light hitting the bottom surface 54 of the top electrode 50 and incident light hitting the top surface 56 of the top electrode 50. Preferably the reflectivity of top electrode 50 is greater than 70%. More preferably, the reflectivity of the top electrode 50 is greater than 80%. Most preferably, the reflectivity of the top electrode 50 is greater than 90%. Appropriate metals for the top electrode 50 include silver, niobium and aluminum, but are not limited to these materials.

Alternatively, the material for the top electrode 50 can be a transparent conductor. If the material for the top electrode 50 is a transparent conductor, the light transmission of the transparent conductor is preferably greater than 90%. The transparent conductor is transmissive to the wavelengths of light generated by multi-layer semiconductor structure 12 of LED 40. Example transparent conductors include, but are not limited to, indium tin oxide (ITO or In₂O₃:Sn), fluorine-doped tin oxide (SnO₂:F) and aluminum-doped zinc oxide (ZnO:Al).

FIG. 3C illustrates the cross-section of LED 60. LED 60 is comprised of a reflecting layer 14 that also serves as a first bottom electrode, a multi-layer semiconductor structure 12, a substrate 64 and a second bottom electrode 66. The multi-layer semiconductor structure 12 is epitaxially grown onto the substrate 64. Internal light beam 62 is emitted by the light emitting diode 60. Externally incident light beam 68 is transmitted through the top surface of the LED 40, reflected by the reflecting layer 14, transmitted back through the LED 40 and transmitted out of the LED 60.

If LED 60 is a GaN LED, the multi-layer semiconductor structure 12 contains at least an n-doped GaN layer 44 that is usually adjacent to the substrate 64, an active layer 46 that emits internally generated light 62 and a p-doped GaN layer 48. The active layer 46 is typically a GaN-based multi-quantum well structure and is located between the n-doped GaN layer 44 and the p-doped GaN layer 48.

The substrate 64 of LED 60 must be at least partially transparent to the internally generated light 62. In this example substrate 64 does not need to be electrically conductive. A typical material for substrate 64 is sapphire (Al₂O₃), which is transparent to visible light.

In order to form a second electrode, an etching process removes portions of the reflecting layer 14, the p-doped layer 48 and the active layer 46, thereby exposing a portion of the n-doped layer 44. A second metallic bottom electrode 66 is formed in contact with the exposed n-doped layer 44.

FIG. 3D illustrates the cross-section of LED 80. LED 80 is similar to LED 40 except that LED 80 does not have a partially transparent substrate. LED 80 is comprised of reflecting layer 14 that also serves as a bottom electrode, a multi-layer semiconductor structure 12 and a top electrode 90. The multi-layer semiconductor structure 12 is formed by epitaxially grown onto a substrate, but the substrate is removed before the top electrode 90 is fabricated. For example, if the substrate is sapphire, a laser separation process can be used to remove the substrate from the multi-layer semiconductor structure 12.

Internal light beam 82 is emitted by the light emitting diode 40. Externally incident light beam 86 is reflected by the top surface 96 of the top electrode 90 without being transmitted through the LED 80. Externally incident light beam 53 is transmitted through the top surface of the LED 80, reflected by the reflecting layer 14, transmitted back through the LED 80 and transmitted out of the LED 80.

If LED 80 is a GaN LED, the multi-layer semiconductor structure 12 contains at least an n-doped GaN layer 44, an active layer 46 that emits internally generated light 82 and a p-doped GaN layer 48. The active layer 46 is typically a GaN-based multi-quantum well structure and is located between the n-doped GaN layer 44 and the p-doped GaN layer 48.

A metallic top electrode 90 is in electrical contact with the n-doped GaN layer 44. The area of the top electrode 90 should be minimized in order for internally generated light to escape from the uncovered area of the multi-layer semiconductor structure 12. The top electrode 90 should have high reflectivity. Preferably the reflectivity of top electrode 90 is greater than 70%. More preferably, the reflectivity of the top electrode 90 is greater than 80%. Most preferably, the reflectivity of the top electrode 90 is greater than 90%. Appropriate metals for the top electrode 90 include, but are not limited to, silver, niobium and aluminum. Alternatively, the material for the top electrode 90 can be a transparent conductor. The materials and characteristics of the top electrode 90 are the same as the materials and characteristics of the top electrode 50 in FIG. 3B.

Returning to FIG. 3A, multi-layer semiconductor structure 12 of LED 10 emits internally generated light 20 through surface 16 and over a first angular range. As stated previously, the angular range is defined as the angular spread between the points on the light output distribution where the light flux per steradian is one half of the peak flux per steradian. For many LEDs, the light output distribution is approximately a Lambertian distribution. For a Lambertian distribution, the light flux per steradian is one-half of the peak value at −60 degrees and at +60 degrees. For such LEDs, the first angular range is 120 degrees or thereabouts.

Reflecting layer 14 reflects both internally generated light 20 and externally incident light 22. Reflecting layer 14 can be a specular reflector or a diffuse reflector. Reflecting layer 14 is usually a metal layer. Appropriate metals include, but are not limited to, silver and aluminum. Reflecting layer 14 should have high reflectivity to the internally generated light and to incident light. Preferably the reflectivity of reflecting layer 14 is at least 80%. More preferably the reflectivity is at least 90%. Most preferably, the reflectivity is at least 95%.

LED 10 has a reflectivity to incident light. The reflectivity of LED 10 depends on several factors including the reflectivity of reflecting layer 14, the absorption coefficient of the multi-layer semiconductor structure 12 and the reflectivity of any top electrodes (not shown) that may be present. Preferably the reflectivity of LED 10 to incident light is at least 70%. More preferably, the reflectivity of LED 10 is at least 80%. Most preferably, the reflectivity of LED 10 is at least 90%.

Note that different sub-areas of an LED surface may not have the same reflectivity to incident light. For example, the sub-area of an LED surface covered by electrodes may have a different reflectivity than the sub-area not covered by electrodes. If different sub-areas of an LED surface do not have the same reflectivity, then the reflectivity of the LED is defined in this specification as the weighted average reflectivity for the entire surface of the LED. The weighting function is the fractional portion of the total area of the LED covered by each sub-area.

Light ray 20 illustrates light emitted by LED 10. Multi-layer semiconductor structure 12 emits light ray 20 through the surface 16.

Externally incident light 22 is not emitted by the LED 10 but generated by an outside light source (not shown). Light ray 22 is incident on the upper surface 16 of the LED, is transmitted through the multi-layer semiconductor structure 12, reflects off the reflecting surface 14, is transmitted back through the multi-layer semiconductor structure 12 and transmitted out through the surface 16.

One embodiment of this invention is illumination system 100 illustrated in FIGS. 4A and 4B. FIG. 4A is a plan view in the X-Y plane of illumination system 100 viewed from above. FIG. 4B is a cross-sectional Z-X view along the I-I plane indicated in FIG. 4A. Illumination system 100 is comprised of LED 10 (illustrated previously in FIG. 3A) and a partially reflecting optical element. In this embodiment, the partially reflecting optical element is pyramid 110.

Pyramid 110 has four connected sides, which are denoted as 112, 113, 114 and 115, and has a base 117. Base 117 is proximal to surface 16 of LED 10 and is also substantially parallel to surface 16. Preferably there is an air gap between surface 16 and base 117.

Light is internally generated by the LED 10 and emitted through the surface 16 of the LED. The emitted light is transmitted through base 117 of the pyramid to be incident upon one or more of the four connected sides 112, 113, 114 and 115 of the pyramid. Side 112 is opposite side 114. Side 113 is opposite side 115. The four sides are connected to base 117. The four sides also form an apex 116 that is distal from surface 16. At the apex, side 112 and side 114 form an interior angle 118. Similarly at the apex, side 113 and side 115 form an interior angle (not shown) equal to interior angle 118. Interior angle 118 is preferably 60 degrees to 120 degrees and more preferably 80 degrees to 100 degrees.

The pyramid 110 is constructed from any solid material that is transparent to the internally generated light of LED 10. Appropriate materials are inorganic crystalline materials, inorganic glasses and transparent polymer materials. Example inorganic crystalline materials include sapphire, cubic zirconia, diamond and garnet materials. Example inorganic glasses include fused silica and BK7 glass. Example polymer materials include polymethylmethacrylate, polycarbonate and polystyrene.

Pyramid 110 is shown in FIGS. 4A and 4B to have four sides. It is also within the scope of this invention that pyramid 110 can have more or less than four sides. For example, pyramid 110 can have three sides or six sides. Whether pyramid 110 has three sides, four sides or more than four sides, the area of the base 117 of pyramid 110 should cover the emitting surface 16 of LED 10 so that pyramid 110 accepts substantially all of the internally generated light emitted by LED 10.

LED 10 emits internally generated light over a first angular range. Pyramid 110 is positioned in the light optical path of the light output of LED 10. A first portion of the internally generated light emitted by LED 10 and directed to pyramid 110 will be transmitted by pyramid 110. A second portion of the internally generated light emitted by LED 10 will undergo total internal reflection by pyramid 110 and will be directed back to LED 10. Whether the light is transmitted or undergoes total internal reflection by pyramid 110 depends on three parameters. The first parameter is the angle of light emission from LED 10 relative to the z-axis, where the z-axis is defined as the direction perpendicular to the surface of LED 10. The second parameter is the interior angle 118 of the pyramid 110. The third parameter is the critical angle θ_{c} for total internal reflection from the sides 112, 113, 114 and 115 of pyramid 110. The critical angle, in turn, depends on the refractive index n of pyramid 110.

If pyramid 110 has a refractive index n and is surrounded by air that has a refractive index of 1.00, light that is inside the pyramid and is incident on a side of the pyramid with an angle less than θ_{c} will exit from the pyramid. Light that is inside the pyramid and is incident on a side of the pyramid with an angle greater than θ_{c} will undergo total internal reflection from the side and be directed toward the opposing side where it can again undergo total internal reflection. After undergoing total internal reflection from two opposing sides of the pyramid, the light is directed back toward the base 117. If the internally reflected light that is inside pyramid 110 is incident on the base 117 at an angle less than the critical angle, which is normally the case for light incident on the base, the light will be transmitted back through the base.

The critical angle θ_{c} is given by

θ_{c}=arcsin(1/n), [Equation 5]

where θ_{c} is measured relative to a direction perpendicular to the appropriate side of pyramid 110 and n is the refractive index of the pyramid. If n=1.50, for example, then θ_{c} is approximately 42 degrees. The side of the pyramid will transmit light that is inside the pyramid and that has incident angles between zero and approximately 42 degrees. Light inside the pyramid that is incident on a side of the pyramid at angles between approximately 42 degrees and 90 degrees will undergo total internal reflection.

The first portion of the internally generated light emitted by LED 10 that is refracted and transmitted by pyramid 110 will have exiting angles from pyramid 110 that are less than the emission angles from LED 10. The emitting angles from LED 10 and the exiting angles from pyramid 110 are both measured relative to the z-axis. If LED 10 emits internally generated light with a first angular range, the first portion of the internally generated light of LED 10 transmitted by pyramid 110 will have a second angular range, less than the first angular range. The magnitude of the second angular range will depend on the magnitude of the first angular range, the interior angle 118 of pyramid 110 and the refractive index of pyramid 110. If the angular output distribution of LED 10 is Lambertian with a first angular range of approximately 120 degrees, preferably the second angular range of light transmitted by pyramid 110 is less than 100 degrees. More preferably the second angular range is less than 90 degrees. As an illustrative example, if the first angular range of LED 10 is 120 degrees, the interior angle 118 of pyramid 110 is 90 degrees and the refractive index of pyramid 110 is 1.50, then the second angular range is approximately 80 degrees.

The second portion of the internally generated light emitted by LED 10 undergoes total internal reflection inside pyramid 110 and is recycled back to LED 10. Reflecting layer 14 of LED 10 can reflect the recycled second portion of the internally generated light. If reflecting layer 14 of LED 10 reflects the recycled light to relatively high angles, the light reflected by the reflecting layer may be transmitted by pyramid 110 and exit illumination system 100. The recycled light that reflects from LED 10 will increase the effective brightness of LED 10.

Light rays 120 and 130 illustrate the operation of illumination system 100. Multi-layer semiconductor structure 12 of LED 10 emits light ray 120 through surface 16 at angle 122. Angle 122 is within a first angular range. Light ray 120 enters pyramid 110 through base 117 and is directed to surface 114 at angle 124. Angle 124 is less than the critical angle. Since angle 124 is less than the critical angle, light ray 120 will be transmitted through surface 114. Light ray 120 exits surface 114 of pyramid 110 at angle 126, measured relative to the z-axis. Due to the refraction of light ray 120 at base 117 and side 114, angle 126 is less than angle 122. Light ray 120 exits pyramid 110 within a second angular range that is smaller than the first angular range of the internally generated light emitted by LED 10.

Multi-layer semiconductor structure 12 emits light ray 130 through surface 16 at angle 132. Angle 132 is within a first angular range. Light ray 130 enters pyramid 110 through base 117 and is directed to surface 114 at angle 134. Angle 134 is greater than the critical angle. Since angle 134 is greater than the critical angle, light ray 130 will undergo total internal reflection by surface 114. Light ray is directed to surface 112 at angle 136. Angle 136 is greater than the critical angle. Light ray 130 will undergo total internal reflection from surface 112 and be directed back to surface 117. Light ray 130 passes through base 117 and is directed toward LED 10. Light ray 130 enters LED 10 through surface 16, is reflected by reflecting layer 14 and exits LED 10 through surface 16 at angle 138. Angle 138 is within a first angular range. Light ray 130 is transmitted by base 117 and is directed to side 112 at angle 140. If angle 138 is a relatively large angle as shown in FIG. 2B, then angle 140 can be less than the critical angle and light ray 130 will be transmitted by surface 112. Angle 138 can be a large angle if, for example, reflecting layer 14 is a diffuse reflector or if multi-layer semiconductor structure 12 scatters light. Light ray 130 exits side 112 and exits the illumination system 100 at angle 142. Angle 142 is within a second angular range. Due to the refraction of light ray 130 at base 117 and side 112, angle 142 that is less than angle 138.

Light ray 120 illustrates that internally generated light emitted from LED 10 at large angles in a first angular range is transmitted by pyramid 110, but exits pyramid 110 at angles smaller than the initial emission angles from LED 10. Light rays emitted from LED 10 that undergo total internal reflection inside pyramid 110 are recycled back to LED 10. Overall, pyramid 110 transmits a first portion of the internally generated light with a second angular range that is smaller than the first angular range, and reflects a second portion of the internally generated light back to LED 10.

Although only the Z-X plane has been shown and discussed, the pyramid 110 also reduces the angular range in the Z-Y plane with the same operation. Accordingly, the pyramid reduces the angular range of the light rays in both the Z-X plane and the Z-Y plane.

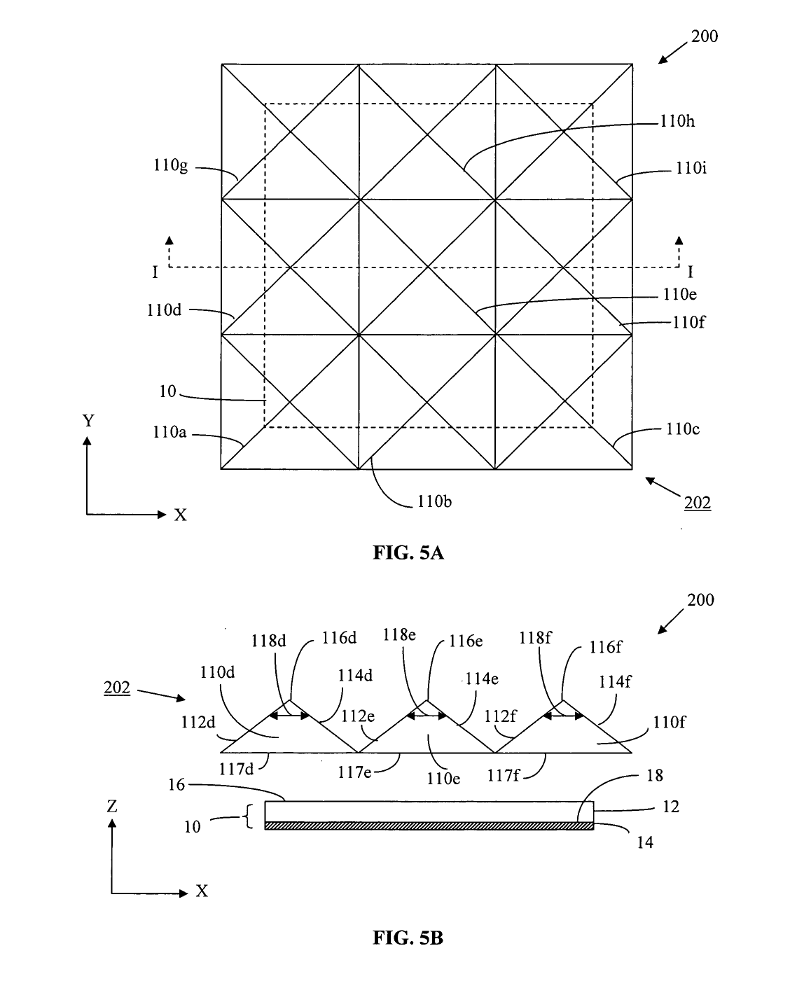

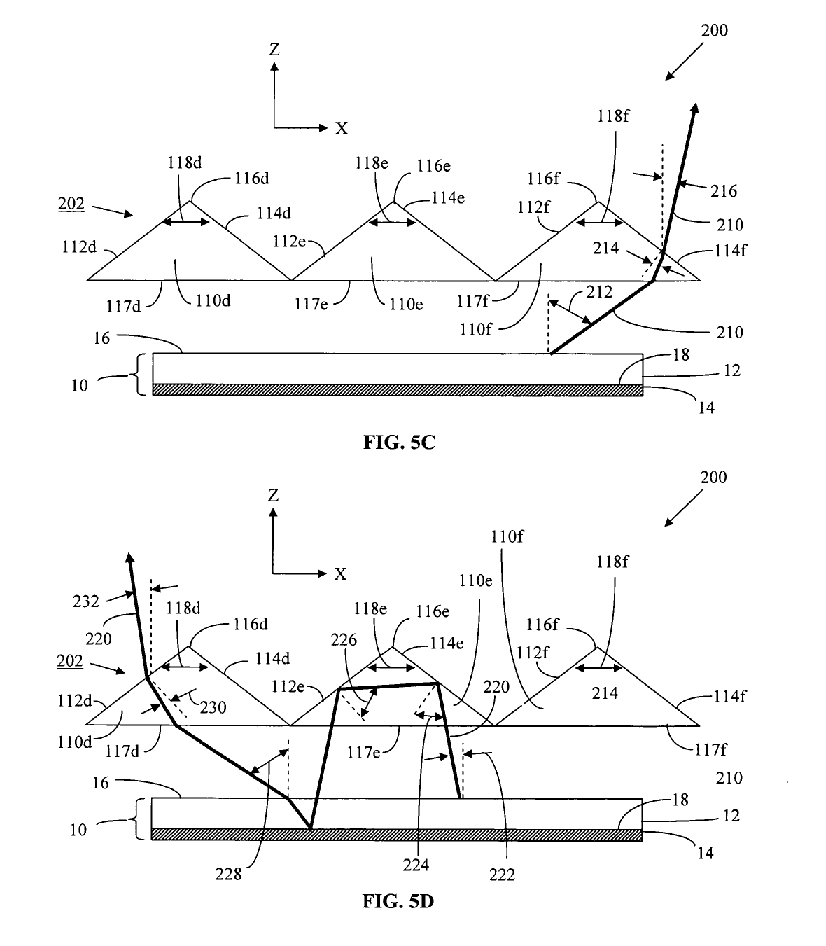

Illumination system 200 illustrated in FIGS. 5A and 5B is another embodiment of this invention. FIG. 5A is a plan view of illumination system 200 viewed from above in the X-Y plane. FIG. 5B is a Z-X cross-sectional side view along the I-I plane indicated in FIG. 5A. FIGS. 5C and 5D are expanded Z-X cross-sectional views of FIG. 5B. Illumination system 200 is comprised of LED 10 (illustrated previously in FIG. 3A) and a partially reflecting optical element.

In this embodiment, the partially reflecting optical element is an array 202 of nine pyramids, arranged as a three-by-three array. The pyramids in the array 202 are denoted as 110a, 110b, 110c, 110d, 110e, 110f, 110g, 110h and 110i. Each pyramid in array 202 is equivalent to pyramid 110 in illumination system 100 and each pyramid in array 202 functions in a similar manner to pyramid 110. Each pyramid in the array has four connected sides that are also connected to a base. The bases of each pyramid in the array 202 are joined to form a close packed planar surface. The four sides of each pyramid form an apex. At each apex, opposing sides of each pyramid form an interior angle. For example, pyramid 110d has base 117d, apex 116d and interior angle 118d. Preferably each pyramid in array 202 is equivalent to the other pyramids in the array and preferably the interior angle of each pyramid is equal to the interior angles of the other pyramids in the array. Preferably the interior angles are in the range of 60 degrees to 120 degrees, more preferably 80 to 100 degrees. Preferable materials for the array of pyramids are identical to the preferred materials for pyramid 110 in illumination system 100.

Although each pyramid in array 202 has four sides, it is also within the scope of this invention that each pyramid can have more or less than four sides. For example, each pyramid in the array can have three sides or six sides and the pyramids can be joined together at the bases to form a close packed array.

The array of pyramids is positioned in the light optical path of the light output of LED 10. The plane formed by the bases of the array of pyramids may be in close proximity with the surface 16 of LED 10 but preferably there is an air gap between surface 16 of LED 10 and the bases of the pyramids.

LED 10 emits internally generated light over a first angular range. A first portion of the internally generated light emitted by LED 10 and directed to the array of pyramids will be transmitted by the array of pyramids. A second portion of the internally generated light emitted by LED 10 will undergo total internal reflection by the array 202 back to LED 10. As in illumination system 100, whether the light is transmitted or reflected by the array of pyramids in illumination system 200 depends on three parameters. The first parameter is the angle of light emission from LED 10 relative to the z-axis, where the z-axis is defined as the direction perpendicular to the surface of LED 10. The second parameter is the interior angle for each pyramid in the array 202. The third parameter is the critical angle θc for total internal reflection from the sides of the array of pyramids. The critical angle, in turn, depends on the refractive index of the array of pyramids.

If the array 202 has a refractive index n and is surrounded by air that has a refractive index of 1.00, light that is inside any pyramid in the array of pyramids and is incident on a side of the pyramid with an angle less than θ_{c} will exit from the pyramid. Light that is inside a pyramid in the array 202 and is incident on a side of the pyramid with an angle greater than θ_{c} will undergo total internal reflection from that side and be directed toward the opposing side where it can again undergo total internal reflection. After undergoing total internal reflection from two opposing sides of the pyramid, the light is directed back toward the base of the pyramid. If the reflected light that is internal to a pyramid is incident on the base of the pyramid at an angle less than the critical angle, which is normally the case for internal light incident on the base, the light will be transmitted through the base.

The first portion of the internally generated light emitted by LED 10 that is transmitted by the array 202 will have exiting angles from the array of pyramids that are less than the emission angles from LED 10. The emitting angles from LED 10 and the exiting angles from the array of pyramids are both measured relative to the z-axis. If LED 10 emits internally generated light with a first angular range, the first portion of the internally generated light of LED 10 transmitted by the array of pyramids will have a second angular range, less than the first angular range. The magnitude of the second angular range will depend on the magnitude of the first angular range, the interior angle of each pyramid in the array of pyramids and the refractive index of the array of pyramids. If the angular output distribution of LED 10 is Lambertian with a first angular range of approximately 120 degrees, preferably the second angular range of light exiting the array of pyramids is less than 100 degrees. More preferably the second angular range is less than 90 degrees. As an illustrative example, if the first angular range of LED 10 is 120 degrees, the interior angle of each pyramid in the array of pyramids is 90 degrees and the refractive index of the array of pyramids is 1.50, then the second angular range is approximately 80 degrees.

The second portion of the internally generated light emitted by LED 10 undergoes total internal reflection inside the array 202 and is recycled back to LED 10. Reflecting layer 14 of LED 10 can reflect the recycled second portion of the internally generated light. If reflecting layer 14 of LED 10 reflects the recycled light to relatively high angles, the light reflected by the reflecting layer may be transmitted by the array of pyramids and exit illumination system 200. The recycled light that reflects from LED 10 will increase the effective brightness of LED 10.

Light rays 210 and 220 illustrate the operation of illumination system 200. Multi-layer semiconductor structure 12 of illumination system 200 emits light ray 210 through surface 16 at angle 212. Angle 212 is within a first angular range. Light ray 210 enters pyramid 110f through base 117f and is directed to surface 114f at angle 214. Angle 214 is less than the critical angle. Since angle 214 is less than the critical angle, light ray 210 will be transmitted through surface 114f. Light ray 210 exits surface 114f of pyramid 110f at angle 216, measured relative to the z-axis. Due to the refraction of light ray 210 at base 117f and side 114f, angle 216 is less than angle 212. Light ray 210 exits pyramid 110f within a second angular range that is smaller than the first angular range of the internally generated light emitted by LED 10.

Multi-layer semiconductor structure 12 of illumination system 200 emits light ray 220 through surface 16 at angle 222. Angle 222 is within a first angular range. Light ray 220 enters pyramid 110e through base 117e and is directed to surface 114e at angle 224. Angle 224 is greater than the critical angle. Since angle 224 is greater than the critical angle, light ray 220 will undergo total internal reflection by surface 114e. Light ray 220 is directed to surface 112e at angle 226. Angle 226 is greater than the critical angle. Light ray 220 will undergo total internal reflection from surface 112e and be directed back to base 117e. Light ray 220 passes through base 117e and is directed toward LED 10. Light ray 220 enters LED 10 through surface 16, is reflected by reflecting layer 14 and exits LED 10 through surface 16 at angle 228. Light ray 220 is transmitted by base 117d of pyramid 110d and is directed to side 112d at angle 230. If angle 228 is a relatively large angle as shown in FIG. 3D, then angle 230 can be less than the critical angle and light ray 220 will be transmitted by surface 112d. Angle 228 can be a large angle if, for example, reflecting layer 14 is a diffuse reflector or if multi-layer semiconductor structure 12 scatters light. Light ray 220 exits side 112d and exits the illumination system 200 at angle 232. Due to the refraction of light ray 220 at base 117d and side 112d, angle 232 that is less than angle 228.

Light ray 210 illustrates that internally generated light emitted from LED 10 at large angles in a first angular range is transmitted by the array of pyramids, but exits the array of pyramids at angles smaller than the initial emission angles from LED 10. Light rays that undergo total internal reflection inside the array of pyramids are recycled by the array of pyramids back to LED 10. Overall, the array of pyramids transmits a first portion of the internally generated light with a second angular range, smaller than the first angular range, and reflects a second portion of the internally generated light back to LED 10.

Although only the Z-X plane has been shown and discussed, the array of pyramids also reduces the angular range in the Z-Y plane with the same operation. Accordingly, the array of pyramids reduces the angular range of the light rays in both the Z-X plane and the Z-Y plane.

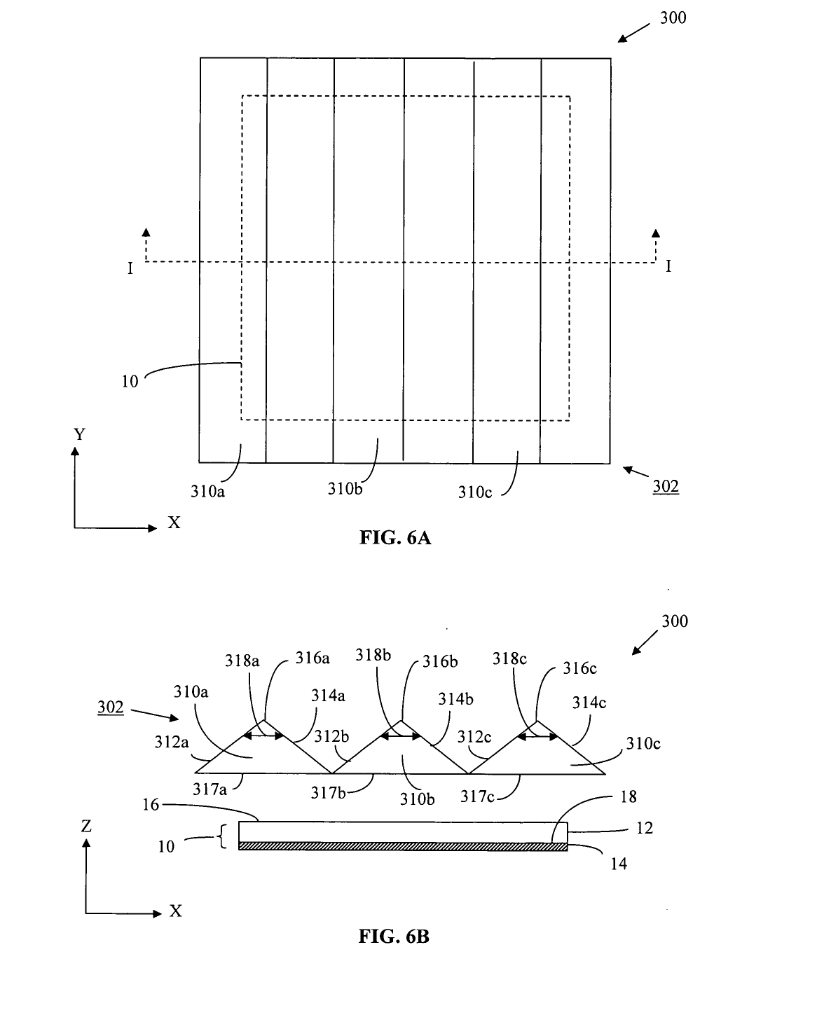

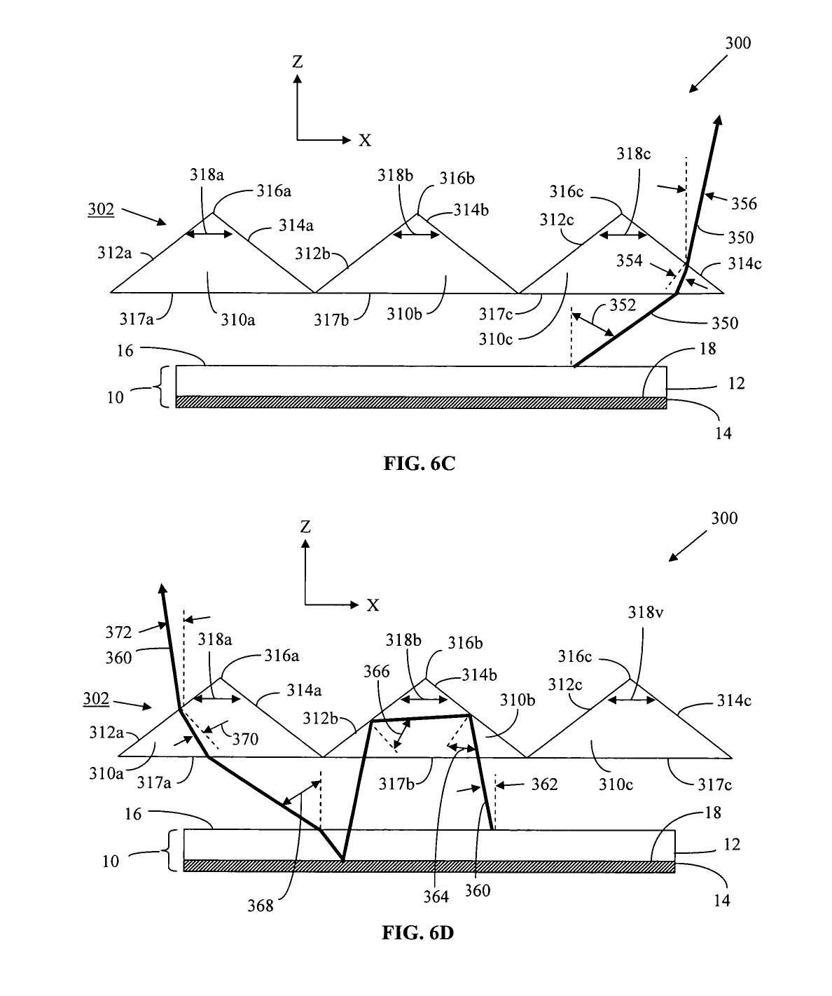

Illumination system 300 illustrated in FIGS. 6A-6D is another embodiment of this invention. FIG. 6A is a plan view of illumination system 300 viewed from above in the X-Y plane. FIG. 6B is a Z-X cross-sectional side view along the I-I plane indicated in FIG. 6A. FIGS. 6C and 6D are expanded Z-X cross-sectional views along the I-I plane. Illumination system 300 is comprised of LED 10 and a partially reflecting optical element.

In this embodiment, the partially reflecting optical element is an array of prisms 302, comprised of three prisms arranged as a one-by-three array. The array is shown with three prisms, but it is within the scope of this invention that the array can have two prisms or more than three prisms. The prisms in the array of prisms 302 are denoted as 310a, 310b and 310c. Each prism in the array has two connected sides and two ends that are all connected to a base. The base of each prism is preferably rectangular in shape. The long axis of each prism is parallel to the Y axis in FIG. 6A. The bases of each prism are joined to form a close packed planar surface. The two sides of each prism form an apex with an interior angle. For example, prism 310a has base 317a, sides 312a and 314a, apex 316a and interior angle 318a. Preferably each prism in the array of prisms 302 is equivalent to the other prisms in the array. Although not a requirement, preferably the interior angle of each prism is equal to the interior angles of the other prisms in the array. Preferably the interior angles are in the range of 60 degrees to 120 degrees, more preferably 80 to 100 degrees. Preferred materials for the array of prisms are identical to the preferred materials for pyramid 110 in illumination system 100. An example of an exemplary array of prisms is “brightness enhancement film” or BEF™ produced by 3M Corporation.

The array of prisms is positioned in the light optical path of the light output of LED 10. The plane formed by the bases 317a, 317b and 317c of the array of prisms 302 is in close proximity with the surface 16 of LED 10. Preferably there is an air gap between surface 16 of LED 10 and the bases of the prisms.

LED 10 in illumination system 300 emits internally generated light over a first angular range. A first portion of the internally generated light emitted by LED 10 and directed to the array of prisms will be transmitted by the array of prisms. A second portion of the internally generated light emitted by LED 10 will undergo total internal reflection by the array of prisms 302 and be recycled back to LED 10. The recycled light that reflects from LED 10 will increase the effective brightness of LED 10. Whether or not the light is transmitted or reflected by the array of prisms in illumination system 300 depends on three parameters. The first parameter is the angle of light emission from LED 10 relative to the z-axis, where the z-axis is defined as the direction perpendicular to the surface of LED 10. The second parameter is the interior angle for each prism in the array. The third parameter is the critical angle θC for total internal reflection from the sides of the array of prisms. The critical angle, in turn, depends on the refractive index of the array of prisms and is given by Equation 5.

If the array of prisms 302 has a refractive index n and is surrounded by air that has a refractive index of 1.00, light that is inside any prism in the array and is incident on a side of a prism with an angle less than θ_{c} will exit from the prism. Light that is inside a prism in the array of prisms 302 and is incident on a side of the prism with an angle greater than θ_{c} will undergo total internal reflection from the side and be directed toward the opposing side where it can again undergo total internal reflection. After undergoing total internal reflection from the two opposing sides of the prism, the light is directed back toward the base of the prism. If the reflected light that is internal to a prism is incident on the base of the prism at an angle less than the critical angle, which is normally the case for internal light incident on the base of the prism, the light will be transmitted through the base.

The internally generated light emitted by LED 10 will be transmitted by the array of prisms 302 with a reduced angular range in the Z-X plane but with no change in the angular range in the Z-Y plane. The emitting angles from LED 10 and the exiting angles from the array of prisms are both measured in the Z-X plane relative to the z-axis. If LED 10 emits internally generated light with a first angular range, the first portion of the internally generated light of LED 10 transmitted by the array of prisms in the Z-X plane will have a second angular range, less than the first angular range. The magnitude of the second angular range in the Z-X plane will depend on the magnitude of the first angular range, the interior angle of each prism in the array of prisms and the refractive index of the array of prisms. If the angular output distribution of LED 10 is Lambertian with a first angular range of approximately 120 degrees, preferably the second angular range of light exiting the array of prisms is less than 100 degrees. More preferably the second angular range is less than 90 degrees. As an illustrative example, if the first angular range of LED 10 is 120 degrees, the interior angle of each prism in the array of prisms is 90 degrees and the refractive index of the array of prisms is 1.50, then the second angular range in the Z-X plane is approximately 80 degrees.

The second portion of the internally generated light emitted by LED 10 undergoes total internal reflection inside the array of prisms 302 and is recycled back to LED 10. Reflecting layer 14 of LED 10 can reflect the recycled second portion of the internally generated light. If reflecting layer 14 of LED 10 reflects the recycled light at relatively high angles towards the array of prisms 302, the light reflected by the reflecting layer 14 may be transmitted by the array of prisms and exit illumination system 300.

Light rays 350 and 360 illustrate the operation of illumination system 300. Multi-layer semiconductor structure 12 of illumination system 300 emits light ray 350 through surface 16 at angle 352 in the Z-X plane. Angle 352 is within a first angular range. Light ray 350 enters prism 310c through base 317c and is directed to surface 314c at angle 354. Since angle 354 is less than the critical angle, light ray 350 will be transmitted through surface 314c. Light ray 350 exits surface 314c of prism 310c at angle 356, measured relative to the z-axis. Due to the refraction of light ray 350 at base 317c and side 314c, angle 356 is less than angle 352. Light ray 350 therefore exits prism 314c within a second angular range in the Z-X plane that is smaller than the first angular range of the internally generated light emitted by LED 10.

Multi-layer semiconductor structure 12 of illumination system 300 emits light ray 360 through surface 16 at angle 362 in the Z-X plane. Angle 362 is within a first angular range. Light ray 360 enters prism 310b through base 317b and is directed to surface 314b at angle 364. Since angle 364 is greater than the critical angle, light ray 360 will undergo total internal reflection by surface 314b. Light ray 360 is directed to surface 312b at angle 366. Angle 366 is greater than the critical angle. Light ray 360 will undergo total internal reflection from surface 312b and be directed back to base 317b. Light ray 360 is directed to base 317b at less than the critical angle, passes through base 317b and is directed toward LED 10. Light ray 360 enters LED 10 through surface 16, passes through the multi-layer semiconductor structure 12, is reflected by reflecting layer 14, again passes through the multi-layer semiconductor structure 12 and exits LED 10 through surface 16 at angle 368. Light ray 360 is transmitted by base 317a of prism 310a and is directed to side 312a at angle 370. If angle 368 is a relatively large angle as shown in FIG. 4D, then angle 370 can be less than the critical angle and light ray 360 will be transmitted by surface 312a. Angle 368 can be a large angle if, for example, reflecting layer 14 is a diffuse reflector or if the multi-layer semiconductor structure 12 scatters light. Light ray 360 exits side 312a and exits the illumination system 300 at angle 372 in the Z-X plane. Because of the refraction of light ray 360 at base 317a and side 312a, angle 372 is less than angle 368.

Light ray 350 illustrates that internally generated light emitted from LED 10 at large angles in a first angular range is transmitted by the array of prisms, but exits the array of prisms at angles in the Z-X plane that are smaller than the initial emission angles from LED 10. Light rays that undergo total internal reflection inside the array of prisms are recycled by the array of prisms back to LED 10. Overall, the array of prisms transmits a first portion of the internally generated light with a second angular range, smaller than the first angular range, and reflects a second portion of the internally generated light back to LED 10.

The array of prisms 302 in illumination system 300 reduces the angular range in the Z-X plane of light transmitted by the array. It is also possible to reduce the angular range of light in the Z-Y plane by using an equivalent array of prisms that is rotated 90 degrees in the X-Y plane relative to the array of prisms 302. This embodiment is illustrated by illumination system 400.

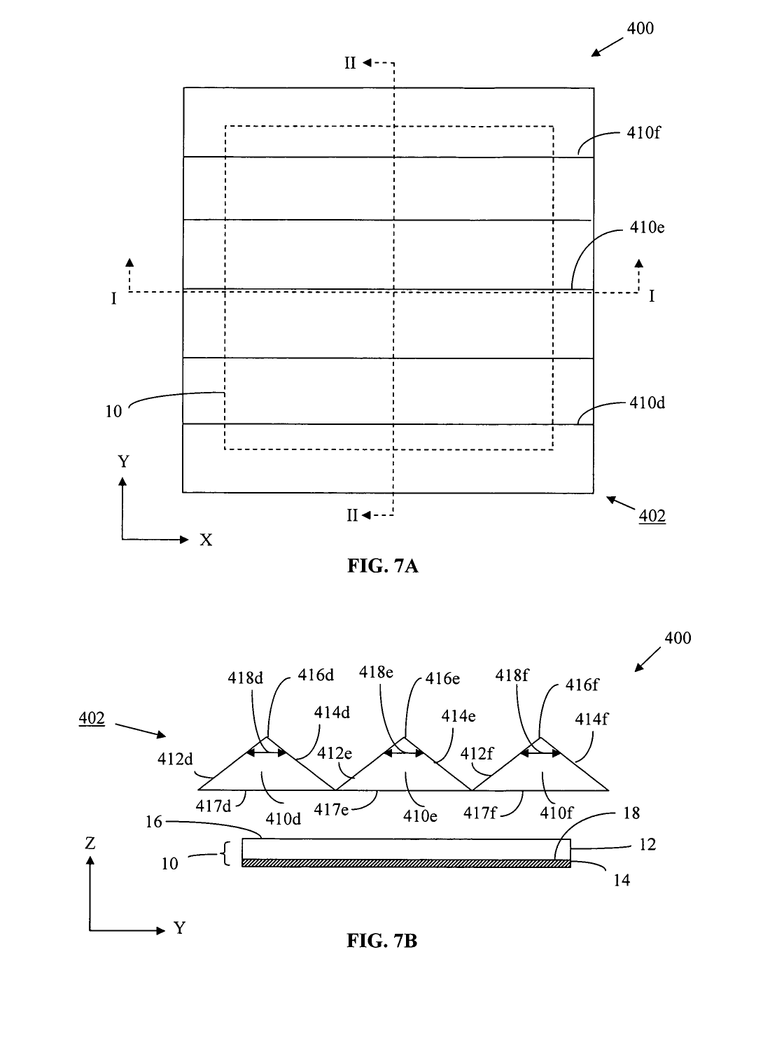

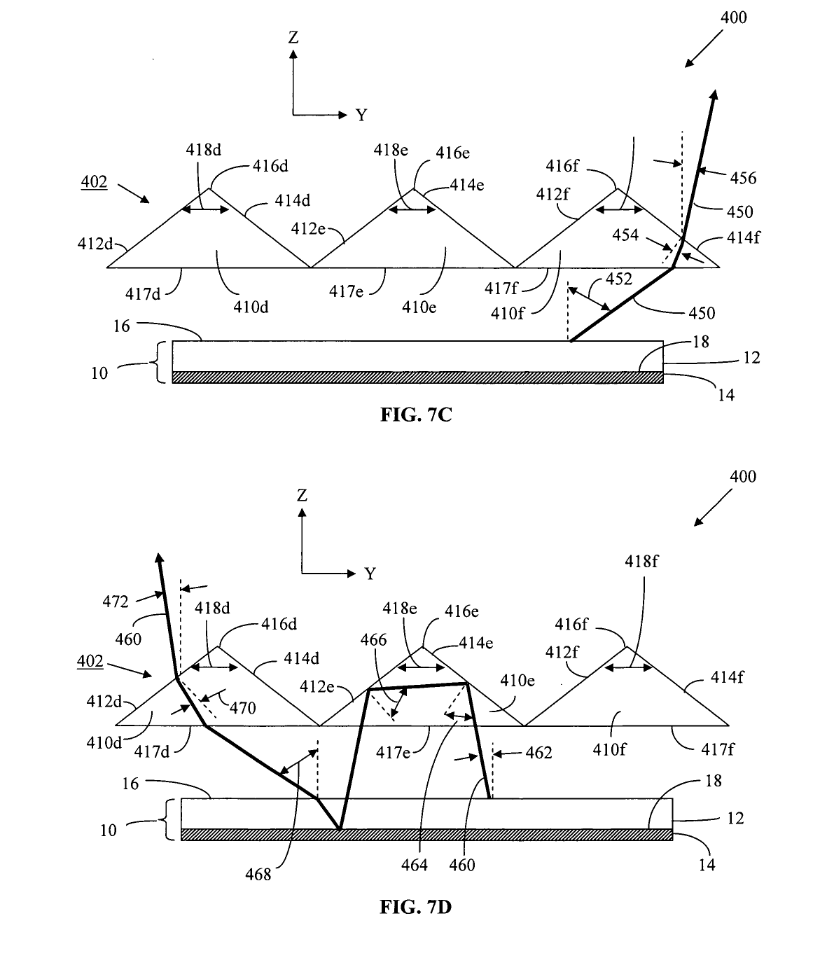

Illumination system 400 illustrated in FIGS. 7A-7D is another embodiment of this invention. FIG. 7A is a plan view of illumination system 400 viewed from above in the X-Y plane. FIG. 7B is a Z-Y cross-sectional side view along the II-II plane indicated in FIG. 7A. FIGS. 7C and 7D are expanded Z-Y cross-sectional views along the II-II plane. Illumination system 400 is comprised of LED 10 and a partially reflecting optical element.

In this embodiment, the partially reflecting optical element is an array of prisms 402, comprised of three prisms arranged as a one-by-three array. It is also within the scope of this invention that the array of prisms 402 may be comprised of two prisms or more than three prisms. The array of prisms 402 in FIGS. 7A-7D is identical to the array of prisms 302 in FIGS. 6A-6D except that the prisms in the array of prisms 402 are aligned with the long axes of the prisms parallel to the X axis instead of the Y axis. The prisms in the array of prisms 402 are denoted as 410d, 410e and 410f. Each prism in the array has two connected sides and two ends that are all connected to a base. The base of each prism is preferably rectangular in shape. The bases of each prism are joined to form a close packed planar surface. The two sides of each prism form an apex with an interior angle. For example, prism 410d has base 417d, sides 412d and 414d, apex 416d and interior angle 418d. Preferably each prism in array is equivalent to the other prisms in the array. Although not a requirement, preferably the interior angle of each prism is equal to the interior angles of the other prisms in the array. Preferably the interior angles are in the range of 60 degrees to 120 degrees, more preferably 80 to 100 degrees. Preferred materials for the array of prisms are identical to the preferred materials for pyramid 110 in illumination system 100. An example of an exemplary array of prisms is BEF™ film produced by 3M Corporation.

The array of prisms is positioned in the light optical path of the light output of LED 10. The plane formed by the bases 417d, 417e and 417f of the array of prisms 402 is in close proximity with the surface 16 of LED 10. Preferably there is an air gap between surface 16 of LED 10 and the bases of the prisms.

LED 10 emits internally generated light over a first angular range. A first portion of the internally generated light emitted by LED 10 and directed to the array of prisms 402 will be transmitted by the array. A second portion of the internally generated light emitted by LED 10 will undergo total internal reflection by the array of prisms 402 and be recycled back to LED 10. The recycled light that reflects from LED 10 will increase the effective brightness of LED 10. Whether or not the light is transmitted or reflected by the array of prisms in illumination system 400 depends on the angle of light emission from LED 10 relative to the z-axis, the interior angle for each prism in the array 302 and the critical angle θc for total internal reflection from the sides of the array of prisms. The critical angle, in turn, depends on the refractive index of the array of prisms and is given by Equation 5.

Light that is inside any prism in the array of prisms 402 and is incident on a side of a prism with an angle less than θ_{c} will exit from the prism. Light that is inside a prism in the array and is incident on a side of the prism with an angle greater than θ_{c} will undergo total internal reflection from the side and be directed toward the opposing side where it can again undergo total internal reflection. After undergoing total internal reflection from the two opposing sides of the prism, the light is directed back toward the base of the prism. If the reflected light that is internal to a prism is incident on the base of the prism at an angle less than the critical angle, which is normally the case for internal light incident on the base, the light will be transmitted through the base.

The internally generated light emitted by LED 10 will be transmitted by the array of prisms 402 with a reduced angular range in the Z-Y plane but with no change in the angular range in the Z-X plane. The emitting angles from LED 10 and the exiting angles from the array of prisms are both measured in the Z-Y plane relative to the z-axis. If LED 10 emits internally generated light with a first angular range, the first portion of the internally generated light of LED 10 transmitted by the array of prisms in the Z-Y plane will have a second angular range, smaller than the first angular range. The magnitude of the second angular range in the Z-Y plane will depend on the magnitude of the first angular range, the interior angle of each prism in the array of prisms and the refractive index of the array of prisms. If the angular output distribution of LED 10 is Lambertian with a first angular range of approximately 120 degrees, preferably the second angular range of light exiting the array of prisms is less than 100 degrees. More preferably the second angular range is less than 90 degrees. As an illustrative example, if the first angular range of LED 10 is 120 degrees, the interior angle of each prism in the array of prisms is 90 degrees and the refractive index of the array of prisms is 1.50, then the second angular range is approximately 80 degrees.

The second portion of the internally generated light emitted by LED 10 undergoes total internal reflection inside the array of prisms 402 and is recycled back to LED 10. Reflecting layer 14 of LED 10 can reflect the recycled second portion of the internally generated light. If reflecting layer 14 of LED 10 reflects the recycled light to relatively high angles, the light reflected by the reflecting layer may be transmitted by the array and exit illumination system 400.

Light rays 450 and 460 illustrate the operation of illumination system 400. Multi-layer semiconductor structure 12 of illumination system 400 emits light ray 450 through surface 16 at angle 452 in the Z-Y plane. Angle 452 is within a first angular range. Light ray 450 enters prism 410f through base 417f and is directed to surface 414f at angle 454. Since angle 454 is less than the critical angle, light ray 450 will be transmitted through surface 414f. Light ray 450 exits surface 414f of prism 410f at angle 456 in the Z-Y plane, measured relative to the z-axis. Due to the refraction of light ray 450 at base 417f and side 414f, angle 456 is less than angle 452. Light ray 450 exits prism 410f within a second angular range in the Z-Y plane that is smaller than the first angular range of the internally generated light emitted by LED 10.

Multi-layer semiconductor structure 12 of illumination system 400 emits light ray 460 through surface 16 at angle 462 in the Z-Y plane. Angle 462 is within a first angular range. Light ray 460 enters prism 410e through base 417e and is directed to surface 414e at angle 464. Since angle 464 is greater than the critical angle, light ray 460 will undergo total internal reflection by surface 414e. Light ray 460 is directed to surface 412e at angle 466. Angle 466 is greater than the critical angle. Light ray 460 will undergo total internal reflection from surface 412e and be directed back to base 417e. Light ray 460 passes through base 417e and is directed toward LED 10. Light ray 460 enters LED 10 through surface 16, passes through the multi-layer semiconductor structure 12, is reflected by reflecting layer 14, again passes through the multi-layer semiconductor structure 12 and exits LED 10 through surface 16 at angle 468 in the Z-Y plane. Light ray 460 is transmitted by base 417d of prism 410d and is directed to side 412d at angle 470. If angle 468 is a relatively large angle as shown in FIG. 5D, then angle 470 can be less than the critical angle and light ray 460 will be transmitted by surface 412d. Angle 468 can be a large angle if, for example, reflecting layer 14 is a diffuse reflector or if the multi-layer semiconductor structure 12 scatters light. Light ray 460 exits side 412d and exits the illumination system 400 at angle 472 in the Z-Y plane. Because of the refraction of light ray 460 at base 417d and side 412d, angle 472 is less than angle 468.

Light ray 450 illustrates that internally generated light emitted from LED 10 at large angles in a first angular range is transmitted by the array of prisms 402, but exits the array at angles in the Z-Y plane that smaller than the initial emission angles from LED 10. Light rays that undergo total internal reflection inside the array of prisms are recycled by the array back to LED 10. Overall, the array of prisms transmits a first portion of the internally generated light in the Z-Y plane with a second angular range, smaller than the first angular range, and reflects a second portion of the internally generated light back to LED 10.

The array of prisms 302 in illumination system 300 reduces the angular range of light transmitted by the array in the Z-X plane. The array of prisms 402 in illumination system 400 reduces the angular range of light transmitted by the array in the Z-Y plane. It is also possible to reduce the angular range of light in all directions relative to the Z axis by using two arrays of prisms, one array with the long axes of the prisms parallel to the Y axis and one array with the long axes of the prisms parallel to the X-axis. Such an embodiment is illustrated by illumination system 500.

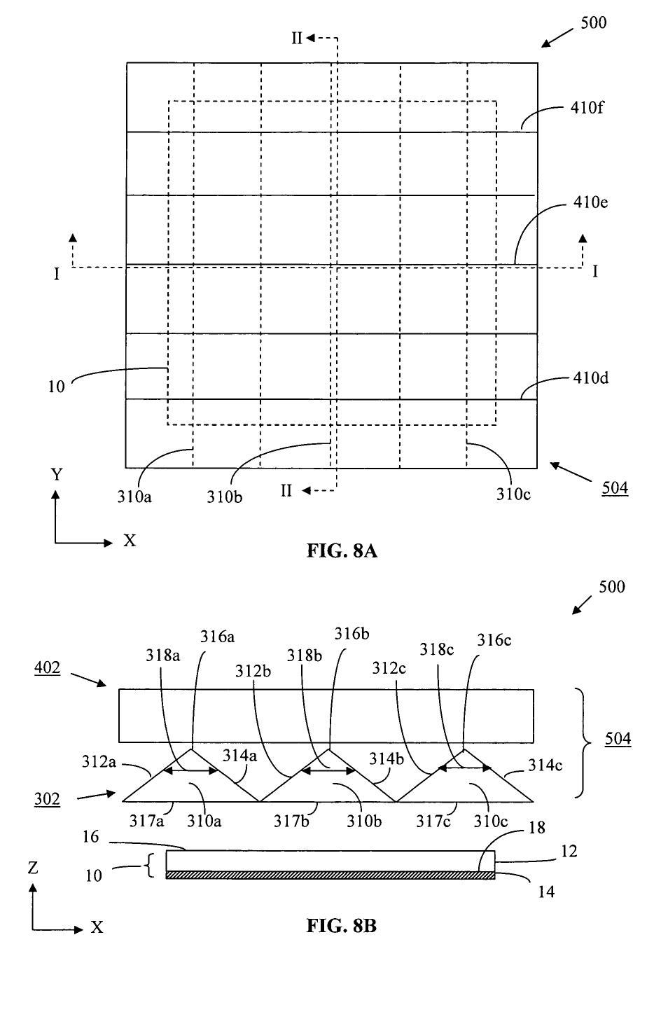

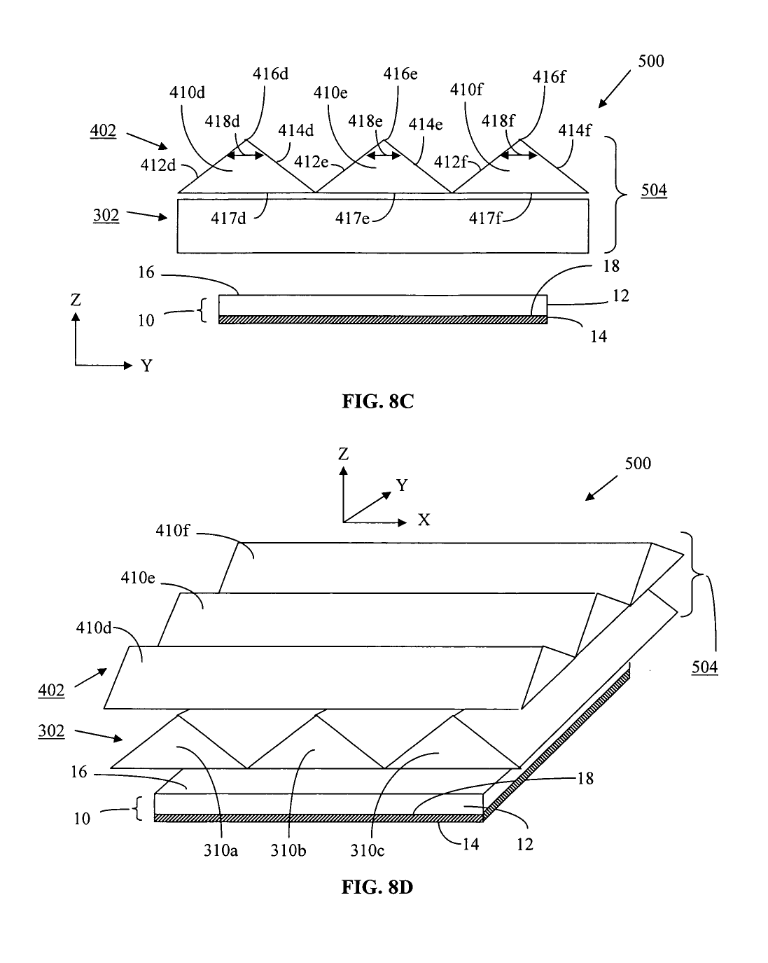

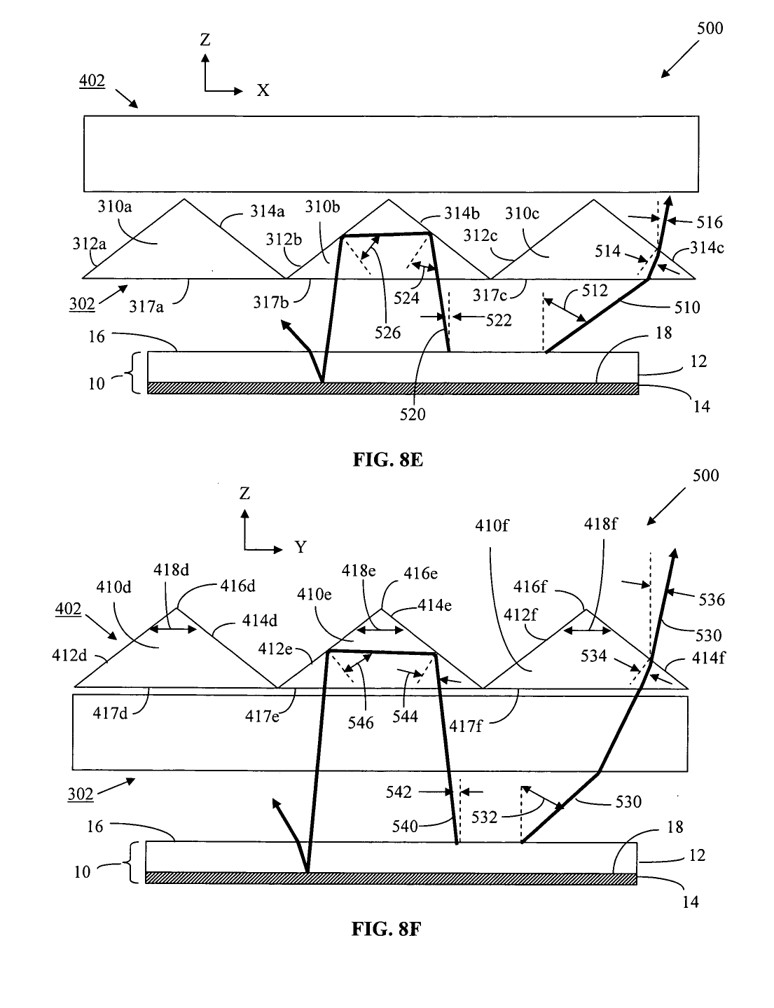

Another embodiment of this invention is illumination system 500 illustrated in FIGS. 8A-8F. Illumination system 500 is comprised of LED 10 and a partially reflecting optical element 504. LED 10 emits internally generated light over a first angular range. In this embodiment, the partially reflecting optical element 504 is comprised of two arrays of prisms, a first array of prisms 302 and a second array of prisms 402. In FIGS. 8A-8F, the first array of prisms 302 is comprised of prisms 310a, 310b and 310c. The second array of prisms 402 is comprised of prisms 410d, 410e and 410f. It is also within the scope of this invention that the first array of prisms 302 and the second array of prisms 402 may each be comprised of two prisms or more than three prisms. The structure and function of the first array of prisms 302 and the second array of prisms 402 have been described previously.

The first array of prisms 302 and the second array of prisms 402 are arranged such that the first array of prisms 302 is substantially perpendicular to the second array of prisms 402. In FIGS. 8A-8F, the first array of prisms 302 is aligned with the long axes of the prisms parallel to the Y axis. The second array of prisms 402 is aligned with the long axes of the prisms parallel to the X axis.

In illumination system 500, the bases of the prisms in the first array of prisms 302 are proximal to the emitting surface 16 of the LED 10. Preferably there is an air gap between the bases of the first array of prisms 302 and emitting surface 16. The apexes of the prisms in the first array of prisms 302 are distal from the emitting surface 16 of the LED 10.

The bases of the prisms in second array of prisms 402 are proximal to the apexes of the prisms in the first array of prisms 302. The bases of the prisms in the second array of prisms 402 may touch the apexes of the prisms of the first array of prisms 302 or there may be an air gap between the two arrays. The apexes of the prisms in the second array of prisms 402 are distal from the apexes of the prisms of the first array of prisms 302.

Light is internally generated by the LED 10 and emitted through the surface 16 of the LED. The emitted light is incident upon the bases of the first array of prisms 302.

The first array of prisms 302 transmits a first portion of the internally generated light emitted by LED 10 and reflects via total internal reflection a second portion of the internally generated light back to LED 10 in a similar manner as illustrated for illumination system 300 in FIGS. 6A-6D. The second array of prisms 402 transmits a first portion of light transmitted by the first array of prisms 302. The second array of prisms 402 reflects via total internal reflection a second portion of the light transmitted by the first array of prisms 302 back through the first array of prisms 302 to LED 10. Light that is recycled back to LED 10 by the first array of prisms 302 and by the second array of prisms 402 can reflect from reflecting layer 14 of LED 10 and be redirected back toward the two arrays of prisms. The recycled light that reflects from LED 10 can increase the effective brightness of LED 10.

If LED 10 of illumination system 500 emits internally generated light with a first angular range in both the Z-X plane and the Z-Y plane, the first array of prisms 302 reduces the angular range of the transmitted light in the Z-X plane but not in the Z-Y plane. Conversely, the second array of prisms 402 reduces the angular range of the transmitted light in the Z-Y plane but not in the Z-X plane. Partially reflecting optical element 504, consisting of both the first array of prisms 302 and the second array of prisms 402, reduces the angular range of the transmitted light in all directions including both the Z-X plane and the Z-Y plane. If the first angular distribution of LED 10 is Lambertian with a first angular range of approximately 120 degrees, preferably the second angular range exiting the two arrays of prisms is less than 100 degrees. More preferably the second angular range is less than 90 degrees. An exemplary array of prisms that can be used for both the first array of prisms 302 and the second array of prisms 402 is BEF™ film produced by 3M Corporation.

FIG. 8A is a plan view of illumination system 500 viewed from above. FIG. 8B is a Z-X cross-sectional side view along the I-I plane indicated in FIG. 8A. FIG. 8C is a Z-Y cross-sectional side view along the II-II plane indicated in FIG. 8A. FIG. 8D is a perspective view. FIG. 8E is an expanded view of FIG. 8B. FIG. 8F is an expanded view of FIG. 8C.

Internally generated light emitted by LED 10 in illumination system 500 can be either transmitted by the first array of prisms 302 to the second array of prisms 402 or can undergo total internal reflection by the first array of prisms 302 and directed back to LED 10. Light rays 510 and 520 in FIG. 6E illustrate the operation of the array of prisms 302 in illumination system 500.

Multi-layer semiconductor structure 12 emits light ray 510 through surface 16 at angle 512 and directed towards prism 310c of the first array of prisms 302. Light ray 510 enters prism 310c through base 317c and is directed to surface 314c at angle 514. Since angle 514 is less than the critical angle, light ray 510 will be transmitted through surface 314c. Light ray 510 exits surface 314c of prism 310c at angle 516, measured relative to the z-axis. Due to the refraction of light ray 510 at base 317c and side 314c, angle 516 is less than angle 512. Light ray 510 exits prism 310c within a second angular range in the Z-X plane that is smaller than the first angular range of the internally generated light emitted by LED 10. Light ray 510 is directed to the second array of prisms 402. Depending on the angle that light ray 510 makes with the Z-Y plane (not shown), light ray 510 will be either transmitted by the second array of prisms 402 or will undergo total internal reflection by the second array of prisms 402 and be directed back through the first array of prisms 302 to LED 10.

Multi-layer semiconductor structure 12 of illumination system 500 emits light ray 520 through surface 16 at angle 522 in the Z-X plane. Angle 522 is within a first angular range. Light ray 520 enters prism 310b through base 317b and is directed to surface 314b at angle 524. Since angle 524 is greater than the critical angle, light ray 520 will undergo total internal reflection by surface 314b. Light ray 520 is directed to surface 312b at angle 526. Angle 526 is greater than the critical angle. Light ray 520 will undergo total internal reflection from surface 312b and be directed back to base 317b. Light ray 520 is directed to base 317b at less than the critical angle, passes through base 317b and is directed toward LED 10. Light ray 520 enters LED 10 through surface 16, passes through the multi-layer semiconductor structure 12, is reflected by reflecting layer 14, again passes through the multi-layer semiconductor structure 12, exits LED 10 through surface 16 and is directed toward the first array of prisms 302. Depending on the angular direction that light ray 520 makes with surface 16, light ray 520 may be transmitted or reflected by the first array of prisms 302 and the second array of prisms 402.

Internally generated light emitted by LED 10 that is transmitted by the first array of prisms 302 to the second array of prisms 402 can then either be transmitted by the second array of prisms 402 or can undergo total internal reflection by the second array of prisms 402 and be directed back through the first array of prisms 302 to LED 10. If light ray 510 that is transmitted by the first array of prisms at angle 516 in the Z-X plane is also transmitted by the second array of prisms 402, then the direction of light ray 510 in the Z-X plane will be substantially unchanged by the transmission through the second array of prisms 402.

Light rays 530 and 540 in FIG. 6F illustrate the operation of the second array of prisms 402 in illumination system 500. Multi-layer semiconductor structure 12 emits light ray 530 through surface 16 at angle 532 and towards the first array of prisms 302. Light ray 530 has the appropriate initial angle to pass through the first array of prisms 302. Light ray 530 is directed to base 417f of prism 410f in the second array of prisms 402. Light ray 530 passes through base 417f and is directed to side 414f at angle 534. Since angle 534 is less than the critical angle, light ray 530 will be transmitted by side 414f of prism 410f. Since light ray 530 is refracted by base 417f and side 414f, light ray 530 exits illumination system 500 at angle 536 that is less than angle 532.

Multi-layer semiconductor structure 12 emits light ray 540 through surface 16 at angle 542 and directed towards the first array of prisms 302. Light ray 540 has the appropriate initial angle to pass through the first array of prisms 302. Light ray 540 is directed to base 417e of prism 410e. Light ray 540 passes through base 417e and is directed to side 414e at angle 544. Since angle 544 is greater than the critical angle, light ray 540 undergoes total internal reflection and is directed to side 412e at angle 546. Since angle 546 is greater than the critical angle, light ray 540 undergoes total internal reflection and is directed through base 417c. Light ray 540 passes through the first array of prisms 302, reenters LED 10 through surface 16. Light ray 540 passes through the multi-layer semiconductor structure 12, is reflected by reflecting layer 14, again passes through the multi-layer semiconductor structure 12, exits LED 10 through surface 16 and is directed towards the first array of prisms 302. Depending on the angular direction that light ray 540 makes with surface 16, light ray 540 may be transmitted or reflected by the first array of prisms 302 and the second array of prisms 402.

Overall, the first array of prisms 302 and the second array of prisms 402 transmit a first portion of the internally generated light emitted by LED 10. The transmitted light has a second angular range that is smaller than the first angular range emitted by LED 10. The first array of prisms 302 and the second array of prisms 402 reflect a second portion of the internally generated light back to LED 10.

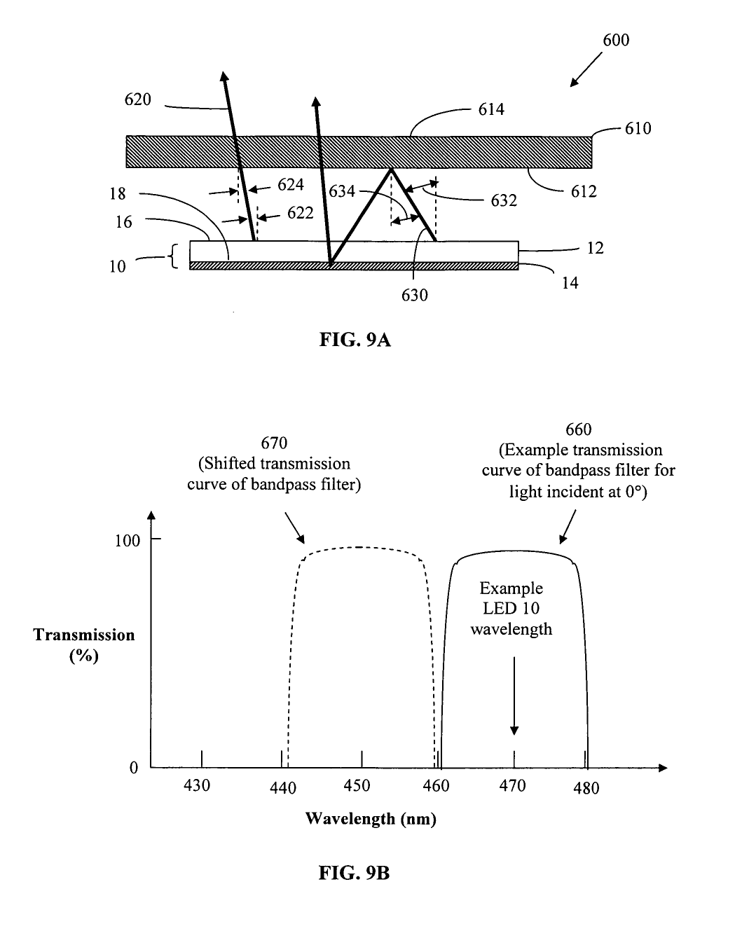

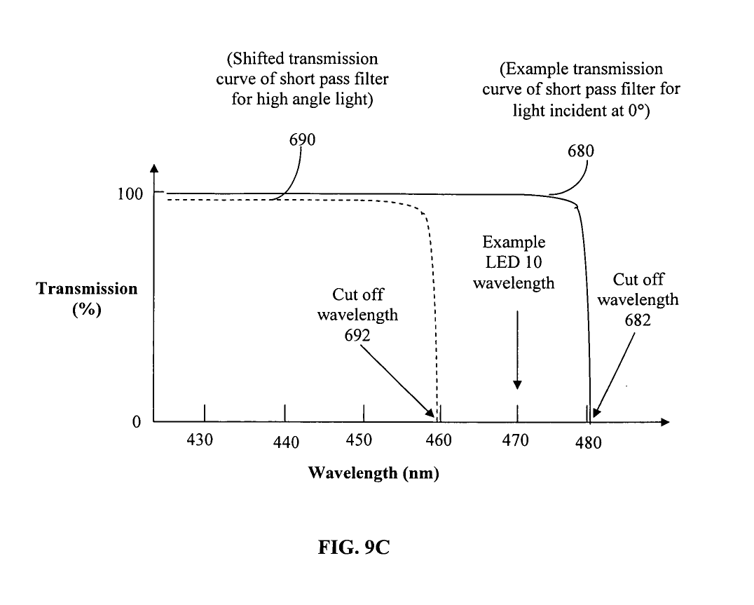

FIG. 9A illustrates a cross-sectional view of another embodiment of this invention denoted as illumination system 600. Illumination system 600 is comprised of LED 10 and a bandpass filter 610. LED 10 is comprised of a multi-layer semiconductor structure 12 and a reflecting layer 14. LED 10 emits internally generated light from surface 16 over a first angular range.

Bandpass filter 610 is a partially reflecting optical element incorporating a multilayer dielectric coating. Bandpass filter 610 has an input surface 612 proximal to the output surface 16 of LED 10 and an output surface 614 distal from surface 16. In FIG. 9A, there is an air gap between LED 10 and bandpass filter 610. However, an air gap is not required. The bandpass filter 610 may be fabricated directly on surface 16 of LED 10. Also in FIG. 9A, the bandpass filter 610 is oriented parallel to the output surface 16 of LED 10, but the parallel orientation is not required if there is an air gap between the bandpass filter 610 and the output surface 16 of LED 10.

The bandpass filter 610 transmits a narrow range of wavelengths in the visible spectrum and reflects other visible wavelengths of light. Referring to FIG. 9B, assume, for example, that LED 10 emits light at 470 nm. Curve 660 in FIG. 9B is a representative curve for the transmission of an appropriate bandpass filter 610 for light incident on the bandpass filter at zero degrees. The incident angle is measured from a line perpendicular to the plane of the bandpass filter. The width of the transmission curve in this example is approximately 20 nanometers, but the width can be more or less than 20 nanometers. If internally generated light emitted by LED 10 is incident on the bandpass filter 610 at an angle of zero degrees or thereabouts, bandpass filter 610 will transmit the internally generated light. However, for light incident at other angles, the transmission curve for bandpass filter 610 shifts to shorter wavelengths. For example, curve 670 is a shifted transmission curve for bandpass filter 610 when light is incident at angle 634. As a result, bandpass filter 610 transmits light incident at small angles less than a cutoff angle. For incident angles greater than the cutoff angle, the incident light will be reflected.

Light rays 620 and 630 illustrate the operation of illumination system 600. Multi-layer semiconductor structure 12 emits light ray 620 through surface 16 at angle 622. Light ray 620 is directed to the input surface 612 of bandpass filter 610 at angle 624. Angle 624 is a small angle that is less than the cutoff angle. Light ray 620 is transmitted by the bandpass filter 610 and exits illumination system 600.

Multi-layer semiconductor structure 12 emits light ray 630 through surface 16 at angle 632. Light ray 630 is directed to the input surface 612 of bandpass filter 610 at angle 634. Light ray 630 is reflected by bandpass filter 610 since angle 634 is larger than the cutoff angle. Bandpass filter 610 thereby restricts the angular output of the illumination system 600 to a second angular range that is less than the first angular range of LED 10.

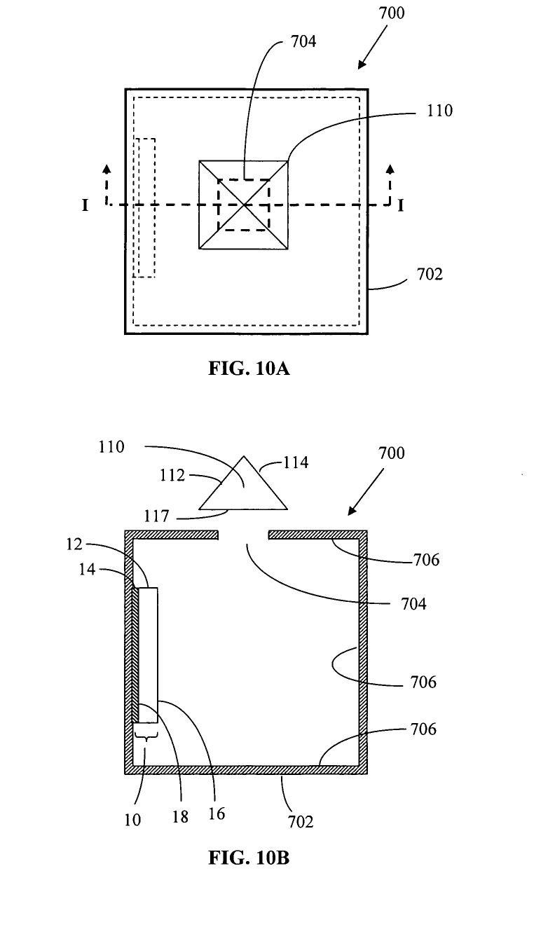

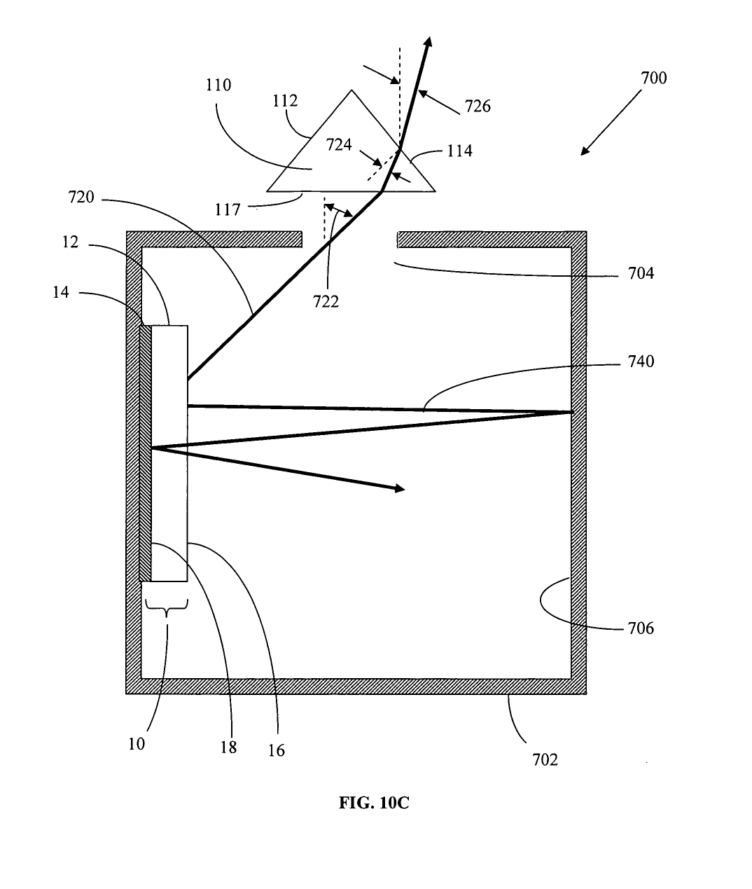

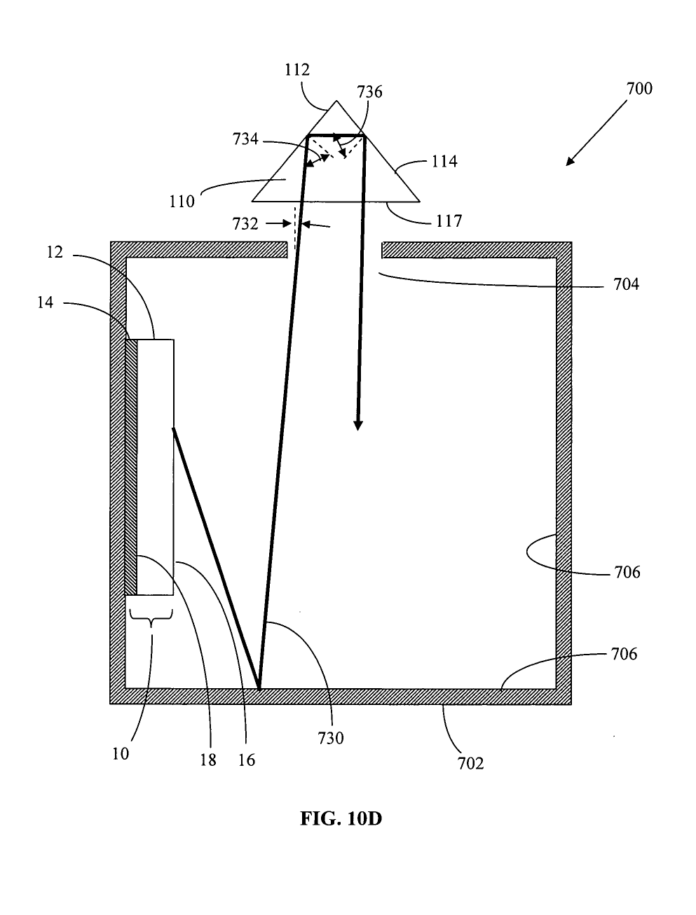

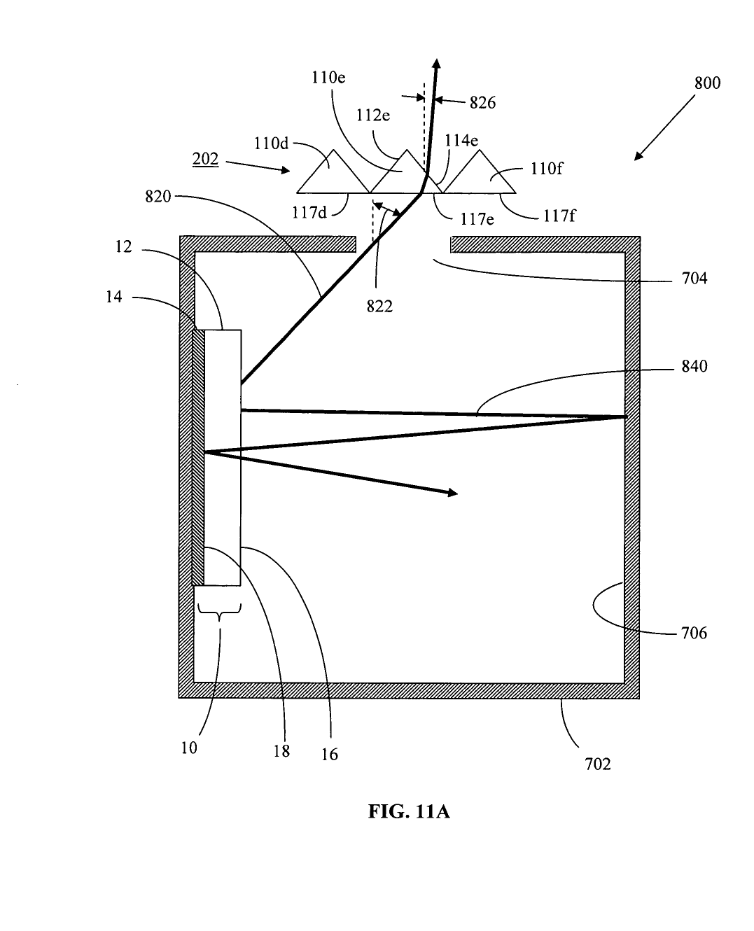

FIGS. 10A-10D, 11A-11B, 12A-12E and 13A-13D are embodiments of this invention that further comprise a light recycling envelope 702. Light recycling envelope 702 encloses LED 10 and has an output aperture 704. The inside surfaces 706 of the light recycling envelope 702 are reflective and may be specular reflectors or diffuse reflectors. Preferably inside surfaces 706 are diffuse reflectors. The reflectivity of inside surfaces 706 is preferably at least 80%. More preferably, the reflectivity of inside surfaces 706 is at least 90%. Most preferably, the reflectivity of inside surfaces 706 is at least 95%. The inside surfaces 706 reflect and recycle light emitted by LED 10 back to LED 10. The recycled light reflects from reflecting layer 14 of LED 10 and increases the effective brightness of LED 10.

Light recycling envelope 702 is shown enclosing LED 10. In general, however, more than one LED may be enclosed in one light recycling envelope. Preferably, as much as possible of the inside area of light recycling envelope, with the exception of the output aperture, is covered by LEDs. The area of the remaining inside surfaces 706 not covered by LEDs is preferably minimized in order to minimize the total inside area of the light recycling envelope.

If the area of the output aperture is less than the total emitting area of the one or more LEDs inside the light recycling envelope, it is possible for the brightness of the light exiting the light recycling envelope to be brighter than the intrinsic brightness of an individual LED in the absence of light recycling. The actual output brightness depends on the reflectivity of LED 10 and the reflectivity of the inside surfaces 706. When the reflectivity of either element is less than 100%, some of the light inside the light recycling envelope will be lost to absorption and will not exit the output aperture 704.

A fraction of the internally generated light emitted by LED 10 will exit output aperture 704 over a first angular range. The first angular range exiting the output aperture 704 may be quite large. For example, in some cases the light output is substantially Lambertian with an angular range of 120 degrees. For illumination system applications that require low values of etendue, it would be desirable to restrict the light exiting the illumination system to a second angular range, smaller than the first angular range, in order to reduce the etendue of the illumination system.

FIGS. 10A-10D illustrate illumination system 700, which is comprised of LED 10, a light recycling envelope 702 that has an output aperture 704 and a four-sided pyramid 110 positioned over the output aperture 704. LED 10 emits internally generated light and has a total emitting area. A fraction of the internally generated light exits output aperture 704 in a first angular range. Preferably the area of the output aperture is less than the total emitting area of LED 10. As discussed above, it is also within the scope of this invention that that the light recycling envelope may contain more than one LED, wherein the multiple LEDs have a total emitting area. If the light recycling envelope incorporates multiple LEDs, preferably the area of the output aperture 704 is less than the total emitting area of the multiple LEDs.

FIG. 10A is a plan view of illumination system 700 viewed from above. FIG. 10B is a cross-sectional side view along the I-I plane illustrated in FIG. 10A. FIGS. 10C and 10D are expanded views of FIG. 10B.

Pyramid 110 has been described previously. The base 117 of pyramid 110 is proximal to output aperture 704 and is in the light optical path of light exiting the light output aperture 704. Pyramid 110 restricts the light exiting illumination system 700 to a second angular range, smaller than the first angular range.

Light rays 720, 730 and 740 in FIGS. 10C and 10D illustrate the operation of illumination system 700. Multi-layer semiconductor structure 12 emits light ray 720 through surface 16. Light ray 720 exits the output aperture 704 at angle 722 and is incident on the base of pyramid 110. Angle 722 is within a first angular range. Light ray 720 is transmitted by base 117 and is directed to side 114 at angle 724. Since angle 724 is less than the critical angle, side 114 transmits light ray 720. Light ray 720 exits pyramid 110 and the illumination system 700 at angle 726, which is smaller than angle 722. Angle 726 is within a second angular range that is less than the first angular range of light exiting output aperture 704.

Multi-layer semiconductor structure 12 emits light ray 730 through surface 16. Light ray 730 is directed to an inside surface 706 of the light recycling envelope 702. Light ray 730 is reflected by the inside surface 706 and is redirected to the output aperture 704. Light ray 730 exits the output aperture at angle 732 and is directed to the base of pyramid 110. Angle 732 is within a first angular range. Light ray 730 passes through surface 117 and is directed to surface 112 at angle 734. Since angle 734 is greater than the critical angle, light ray 730 undergoes total internal reflection and is directed to side 114 at angle 736. Since angle 736 is greater than the critical angle, light ray 730 undergoes total internal reflection and is recycled back through surface 117 and back into the light recycling envelope through the output aperture 704. Light ray 730 can then be reflected one or more times inside the light recycling envelope and may eventually again exit again through output aperture 704, but at an angle that allows light ray 730 to be transmitted by pyramid 110.

Multi-layer semiconductor structure 12 emits light ray 740 through surface 16 and directed into the interior of the light recycling envelope a first time. Light ray 740 is reflected back to LED 10 by inside surfaces 706. Light ray 740 passes through surface 16 and the multi-layer semiconductor structure 12 and is reflected by reflecting layer 14. Light ray 740 passes through the multi-layer semiconductor structure 12 and surface 16 and enters the interior of the light recycling envelope a second time. The reflection of light ray 740 by the reflecting layer 14 increases the effective brightness of LED 10.

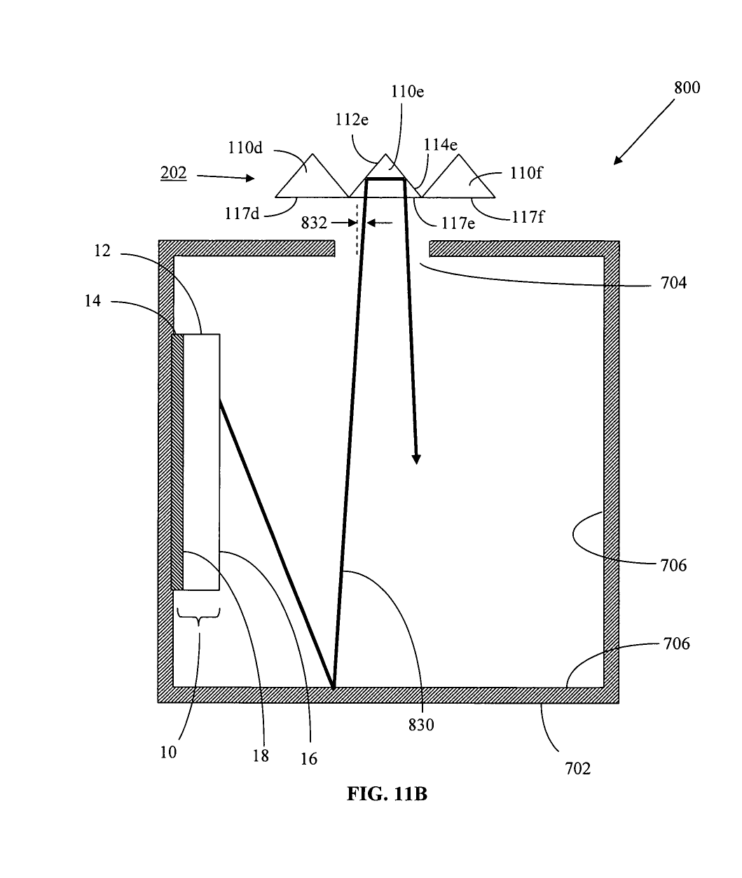

Illumination system 800 illustrated in cross section in FIGS. 11A and 11B is similar to illumination system 700 except that illumination system 800 incorporates an array of pyramids 202. Illumination system 800 is comprised of LED 10, a light recycling envelope 702 that has an output aperture 704 and a three-by-three array of pyramids 202 positioned over the output aperture 704. The three-by-three array of pyramids 202 has been described previously in illumination system 200. In the cross section shown in FIGS. 11A and 11B, three of the nine pyramids, pyramids 110d, 110e and 110f, are illustrated. A fraction of the internally generated light exits output aperture 704 in a first angular range.

Preferably the area of the output aperture 704 is less than the total emitting area of LED 10. As discussed above, it is also within the scope of this invention that that the light recycling envelope may contain more than one LED, wherein the multiple LEDs have a total emitting area. If the light recycling envelope incorporates multiple LEDs, preferably the area of the output aperture 704 is less than the total emitting area of the multiple LEDs.

The bases 117d, 117e and 117f of the array of pyramids 202 are proximal to output aperture 704 and is in the light optical path of light exiting the light output aperture 704. The array of pyramids 202 restricts the light exiting illumination system 800 to a second angular range, smaller than the first angular range.

Light rays 820, 830 and 840 in FIGS. 11A and 11D illustrate the operation of illumination system 800. Multi-layer semiconductor structure 12 emits light ray 820 through surface 16. Light ray 820 exits the output aperture 704 at angle 822 and is incident on the base 117e of pyramid 110e. Angle 822 is within a first angular range. Light ray 820 is transmitted by base 117e and is directed to side 114e at an angle less than the critical angle. Side 114e transmits light ray 820. Light ray 820 exits pyramid 110e and the illumination system 800 at angle 826. Angle 826 is smaller than angle 822 due to the refraction of light at surfaces 117e and 114e. Angle 826 is within a second angular range that is less than the first angular range of light exiting output aperture 704.

Multi-layer semiconductor structure 12 emits light ray 830 through surface 16 and directed to one of the inside surfaces 706 of the light recycling envelope 702. Light ray 830 is reflected by the inside surfaces 706 and is redirected to the output aperture 704. Light ray 830 exits the output aperture at angle 832 and is directed to the base of pyramid 110e. Angle 832 is within a first angular range. Light ray 830 passes through surface 117e and is directed to surface 112e. Light ray 830 is directed to surfaces 112e and 114e at angles that are greater than the critical angle and undergoes total internal reflection at both surfaces. Light ray is recycled back through surface 117e and back into the light recycling envelope via the output aperture 704. Light ray 830 can then be reflected one or more times inside the light recycling envelope and may eventually again exit through output aperture 704, but at an angle that allows light ray 730 to be transmitted by the array of pyramids 202.

Multi-layer semiconductor structure 12 emits light ray 840 through surface 16 and directed into the interior of the light recycling envelope a first time. Light ray 840 is reflected back to LED 10 by inside surfaces 706. Light ray 840 passes through surface 16 and the multi-layer semiconductor structure 12 and is reflected by reflecting layer 14. Light ray 840 again passes through the multi-layer semiconductor structure 12 and surface 16 and enters the interior of the light recycling envelope a second time. The reflection of light ray 840 by the reflecting layer 14 increases the effective brightness of LED 10.

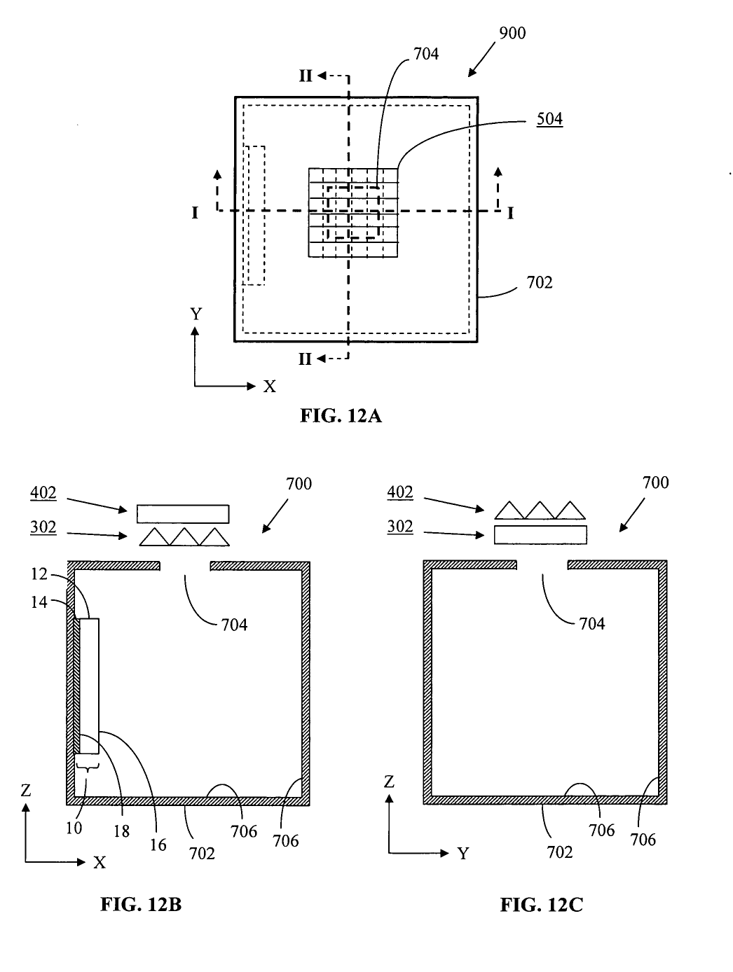

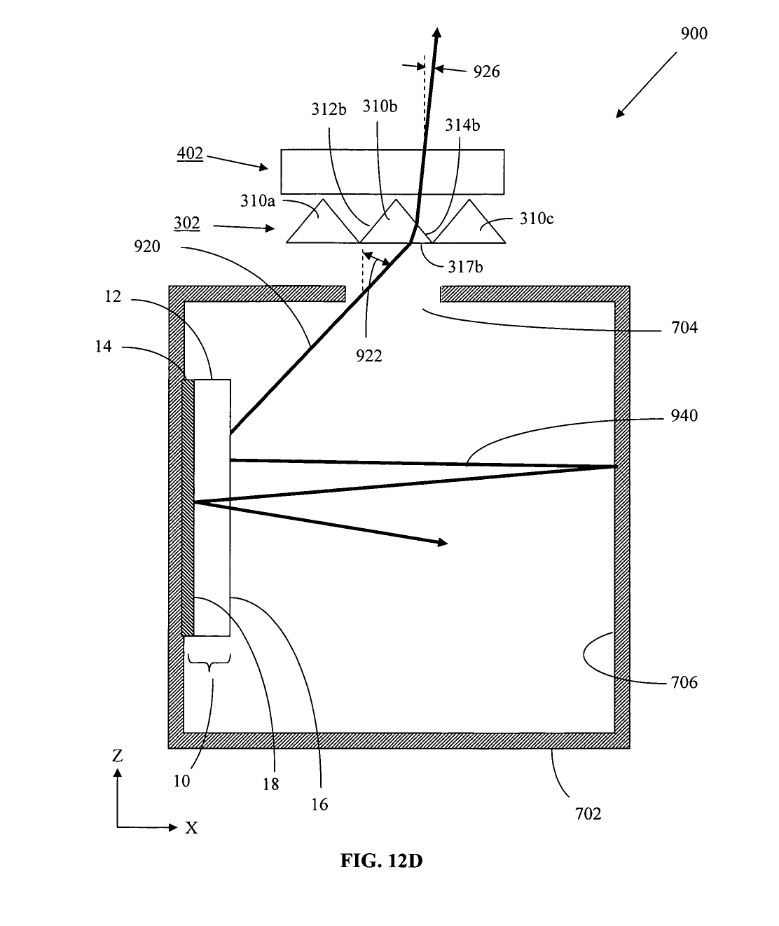

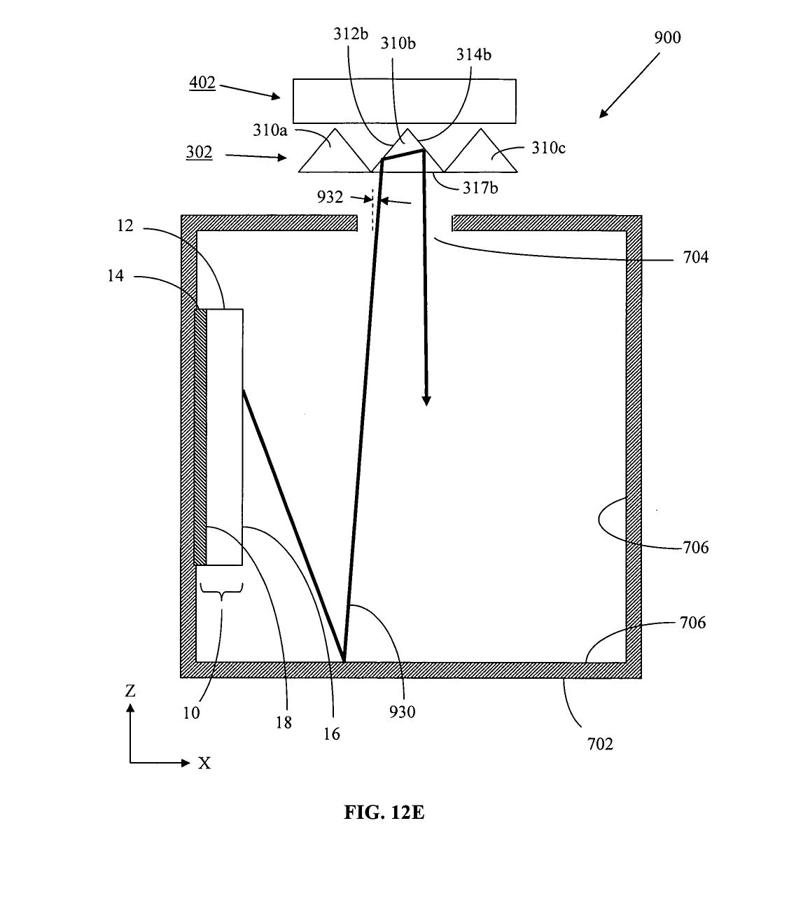

Another embodiment of this invention is illumination system 900 illustrated in FIGS. 12A-12E. Illumination system 900 is comprised of LED 10, a light recycling envelope 702 and a partially reflecting optical element 504. LED 10 emits internally generated light. A fraction of the internally generated light exits the output aperture 704 of the light recycling envelope 702 over a first angular range.

Preferably the area of the output aperture is less than the total emitting area of LED 10. As discussed above, it is also within the scope of this invention that that the light recycling envelope can contain more than one LED, wherein the multiple LEDs have a total emitting area. If the light recycling envelope incorporates multiple LEDs, preferably the area of the output aperture is less than the total emitting area of the multiple LEDs.

The light recycling envelope 702 and the partially reflecting optical element 504 have been described previously. The partially reflecting optical element 504 is comprised of two arrays of prisms, a first array of prisms 302 and a second array of prisms 402. The structure and function of the first array of prisms 302 and the second array of prisms 402 have been described previously.

The first array of prisms 302 and the second array of prisms 402 are arranged such that the first array of prisms 302 is substantially perpendicular to the second array of prisms 402. In FIGS. 12A-12E, the first array of prisms 302 is aligned with the long axes of the prisms parallel to the Y axis. The second array of prisms 402 is aligned with the long axes of the prisms parallel to the X axis.

In illumination system 900, the bases of the prisms in the first array of prisms 302 are proximal to the emitting surface 16 of the LED 10. Preferably there is an air gap between the bases of the first array of prisms 302 and emitting surface 16. The apexes of the prisms in the first array of prisms 302 are distal from the emitting surface 16 of the LED 10.

The bases of the prisms in second array of prisms 402 are proximal to the apexes of the prisms of the first array. The bases of the prisms in the second array of prisms 402 may touch the apexes of the prisms of the first array of prisms 302 or there may be an air gap between the two arrays. The apexes of the prisms in the second array of prisms 402 are distal from the apexes of the prisms of the first array of prisms 302.

The first array of prisms 302 transmits a first portion of the internally generated light exiting the light output aperture 704 and reflects via total internal reflection a second portion of the internally generated light back through the light output aperture 704 and back into the light recycling envelope. The second array of prisms 402 transmits a first portion of light transmitted by the first array of prisms 302. The second array of prisms 402 reflects via total internal reflection a second portion of the light transmitted by the first array of prisms 302 back through the first array of prisms 302, back through the light output aperture and into the light recycling envelope. Light that is recycled back into the light recycling envelope can then be reflected one or more times inside the light recycling envelope and may eventually exit again through output aperture 704. The recycled light that reflects from LED 10 can increase the effective brightness of LED 10.

If the internally generated light exits the output aperture 704 of illumination system 900 with a first angular range in both the Z-X plane and the Z-Y plane, the first array of prisms 302 reduces the angular range of the transmitted light in the Z-X plane but not in the Z-Y plane. Conversely, the second array of prisms 402 reduces the angular range of the transmitted light in the Z-Y plane but not in the Z-X plane. Partially reflecting optical element 504, consisting of both the first array of prisms 302 and the second array of prisms 402, reduces the angular range of the transmitted light in all directions including both the Z-X plane and the Z-Y plane. If the first angular distribution of light exiting the output aperture is Lambertian with a first angular range of approximately 120 degrees, preferably the second angular range exiting the two arrays of prisms is less than 100 degrees. More preferably the second angular range is less than 90 degrees. An exemplary array of prisms that can be used for both the first array of prisms 302 and the second array of prisms 402 is BEF™ film produced by 3M Corporation.

FIG. 12A is a plan view of illumination system 900 viewed from above in the X-Y plane. FIG. 12B is a cross-sectional Z-X side view along the I-I plane indicated in FIG. 12A. FIG. 12C is a cross-sectional Z-Y side view along the II-II plane indicated in FIG. 12A. FIGS. 12D and 12E are expanded views of FIG. 12B.

Light rays 920, 930 and 940 FIGS. 12D and 12E illustrate the operation of the array of prisms 302 in illumination system 900. The operation of the array of prisms 402 has been illustrated previously in illumination system 500 and will not be repeated for illumination system 900.

Multi-layer semiconductor structure 12 emits light ray 920 through surface 16. Light ray 920 is directed through the output aperture 704 at angle 922 in the Z-X plane. Angle 922 is within a first angular range. Light ray 920 enters prism 310b through base 317b and is directed to surface 314b. Light ray 920 strikes surface 314b at less than the critical angle and is transmitted to the second array of prisms 402. In this example, light ray 920 is transmitted by the second array of prisms 402 and exits illumination system 900 at angle 926 in the Z-X plane. Angle 926 is less than angle 922 and is within a second angular range.

Note that internally generated light that is transmitted by the first array of prisms 302 to the second array of prisms 402 can either be transmitted by the second array of prisms 402 or can undergo total internal reflection by the second array of prisms 402 and be directed back through the first array of prisms 302 and into the light recycling envelope. If light ray 920 that is transmitted by the first array of prisms in the Z-X plane is also transmitted by the second array of prisms 402, then the transmission angle in the Z-X plane will be substantially unchanged by the transmission through the second array of prisms 402.

Overall, the first array of prisms 302 and the second array of prisms 402 transmit a first portion of the internally generated light exiting the output aperture 704 of the light recycling envelope 702. The transmitted light has a second angular range that is smaller than the first angular range exiting the output aperture.

Multi-layer semiconductor structure 12 in illumination system 900 emits light ray 930 through surface 16. Light ray 930 is directed to an inside surface 706 where it is reflected. Inside surface 706 directs light ray 930 through output aperture 704 at angle 932. Angle 932 is within a first angular range. Light ray 930 enters prism 310b through base 317b at an angle such that light ray 930 undergoes total internal reflection at surfaces 312b and 314b. Light ray 930 is directed back through base 317b and is recycled back into the light recycling envelope 702 through output aperture 704.

Multi-layer semiconductor structure 12 emits light ray 940 through surface 16 and directed towards the inside surfaces 706 of the light recycling envelope 702. Light ray 940 is reflected by the inside surfaces 706 and directed back to LED 10. Light ray 940 passes through surface 16 of LED 10, passes though the multi-layer semiconductor structure 12 and is reflected by reflecting layer 14. Light ray 940 again passes through the multi-layer semiconductor structure 12 and surface 16 and reenters the interior of the light recycling envelope. The reflection of light ray 940 by LED 10 increases the effective brightness of LED 10.

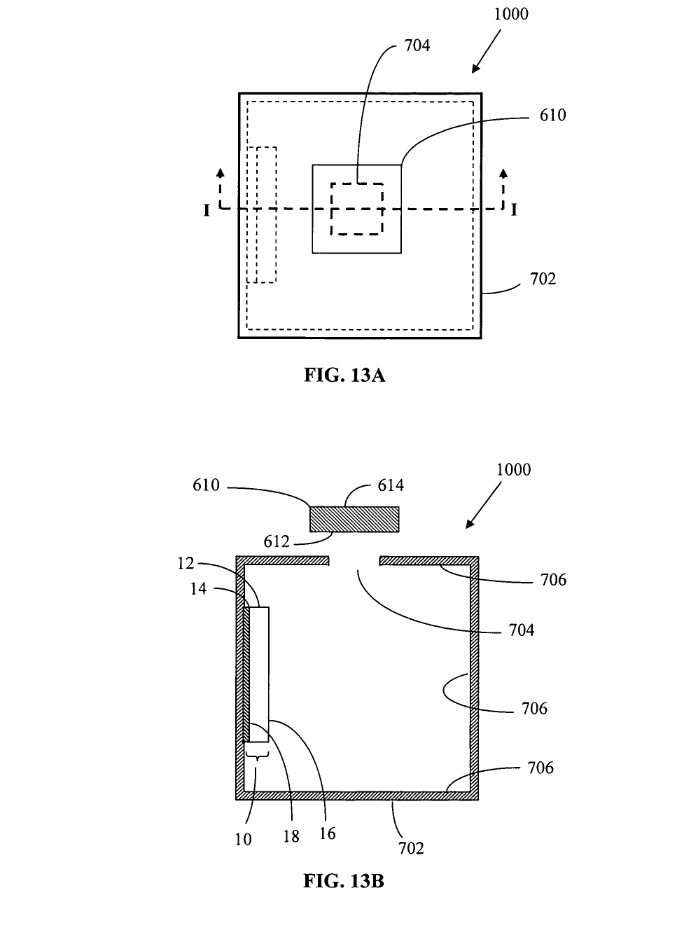

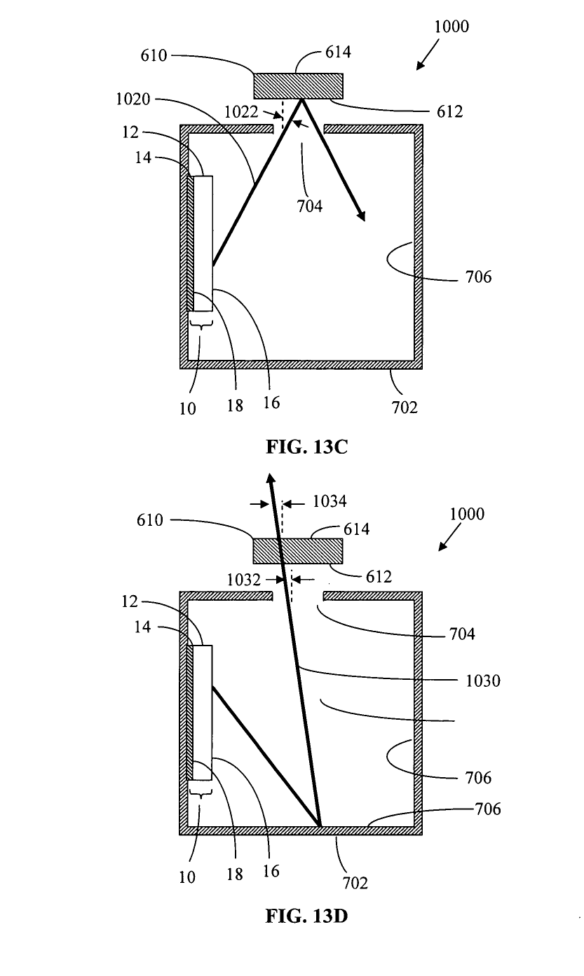

FIGS. 13A-13D illustrate illumination system 1000, which is comprised of LED 10, a light recycling envelope 702 and a bandpass filter 610. Light recycling envelope 702 has an output aperture 704. A fraction of the internally generated light emitted by LED 10 exits output aperture 704 over a first angular range.

Preferably the area of the output aperture is less than the total emitting area of LED 10. As discussed above, it is also within the scope of this invention that that the light recycling envelope can contain more than one LED, wherein the multiple LEDs have a total emitting area. If the light recycling envelope incorporates multiple LEDs, preferably the area of the output aperture is less than the total emitting area of the multiple LEDs.

The characteristics and properties of bandpass filter 610 have been described previously for illumination system 600. Bandpass filter 610 is proximal to output aperture 704 and is in the light optical path of light exiting the light output aperture 704.

Bandpass filter 610 restricts the light exiting illumination system 1000 to a second angular range, smaller than the first angular range. Light rays 1020 and 1030 illustrate the operation of illumination system 1000.

Multi-layer semiconductor structure 12 emits light ray 1020 through surface 16 and directed towards output aperture 704. Light ray 1020 exits the output aperture 704 at angle 1022. Angle 1022 is within a first angular range. Since angle 1022 is greater than the cutoff angle for bandpass filter 610, light ray 1020 is reflected back into the light recycling envelope 702 through output aperture 704. Light ray 1020 may then reflect one or more times inside light recycling envelope and may eventually exit output aperture 704 at an angle that is small enough allow passage through bandpass filter 610.

Multi-layer semiconductor structure 12 emits light ray 1030 though surface 16 and towards the inside surfaces 706 of the light recycling envelope 702. The inside surfaces 706 reflect light ray 1030 and direct light ray 1030 to output aperture 704. Light ray 1030 exits the output aperture at angle 1032. Angle 1032 is within a first angular range and is also less than the cutoff angle for bandpass filter 610. Light ray is transmitted by bandpass filter 610 and exits illumination system 1000 at angle 1034. Angle 1034 is within a second angular range. Overall, bandpass filter 610 restricts the angular range of light exiting illumination system 1000 to a second angular range, less than the first angular range.

While the invention has been described in conjunction with specific embodiments, it is evident to those skilled in the art that many alternatives, modifications and variations will be evident in light of the foregoing descriptions. Accordingly, the invention is intended to embrace all such alternatives, modifications and variations as fall within the spirit and scope of the appended claims.

What is claimed is:

1. An illumination system, comprising:
at least one light emitting diode, wherein said at least one light emitting diode emits internally generated light having a first angular range and wherein said at least one light emitting diode has a reflectivity to incident light; and
a partially reflecting optical element, wherein said partially reflecting optical element is located in the light optical path of said internally generated light, wherein said partially reflecting optical element transmits a first portion of said internally generated light with a second angular range, smaller than said first angular range, and wherein said partially reflecting optical element reflects a second portion of said internally generated light back to said at least one light emitting diode.

2. An illumination system as in claim 1, wherein said partially reflecting optical element is at least one pyramid, wherein the base of said pyramid is proximal to said at least one light emitting diode, wherein the apex of said pyramid is distal from said at least one light emitting diode, wherein said first portion of said internally generated light is transmitted by refraction with said second angular range by said pyramid and wherein said second portion of said internally generated light undergoes total internal reflection by said pyramid and is directed back to said at least one light emitting diode.

3. An illumination system as in claim 2, wherein said pyramid has four connected sides and a base.

4. An illumination system as in claim 3, wherein said partially reflecting optical element is an array of said pyramids.

5. An illumination system as in claim 1, wherein said partially reflecting optical element is a first array of prisms and a second array of prisms, wherein said second array of prisms is substantially perpendicular to said first array of prisms, wherein each said prism in said first array of prisms and each said prism in said second array of prisms has two equal sides forming an apex, said two equal sides connected to a base, wherein the bases of said first array of prisms are proximal to said at least one light emitting diode, wherein the apexes of said first array of prisms are distal from said at least one light emitting diode, wherein said bases of said second array of prisms are proximal to said apexes of said first array of prisms, wherein said apexes of said second array of prisms are distal from said apexes of said first array of prisms, wherein said first portion of said internally generated light is transmitted by refraction with said second angular range through said first array of prisms and said second array of prisms and wherein said second portion of said internally generated light undergoes total internal reflection by either said first array of prisms or said second array of prisms and is directed back to said at least one light emitting diode.

6. An illumination system as in claim 1, wherein said partially reflecting optical element is a bandpass filter, wherein said bandpass filter incorporates a multi-layer dielectric coating that transmits light that has a wavelength range and that has an incident angle that is less than a cutoff angle and wherein said multi-layer dielectric coating reflects light that has said wavelength range and that has an incident angle that is greater than said cutoff angle.

7. An illumination system as in claim 1, wherein said reflectivity to said incident light is at least 70 percent.

8. An illumination system as in claim 7, wherein said reflectivity to said incident light is at least 80 percent.

9. An illumination system as in claim 8, wherein said reflectivity to said incident light is at least 90 percent.
